(19) United States
(12) Patent Application Publication
(10) Pub. No.: US 2012/0113835 A1
(43) Pub. Date: May 10, 2012

(54) INTER-NETWORK CARRIER ETHERNET SERVICE PROTECTION

(75) Inventors: Zehavit Alon, Raanana (IL); Nurit Sprecher, Petach Tikva (IL)

(73) Assignee: NOKIA SIEMENS NETWORKS OY, ESPOO (FI)

(21) Appl. No.: 13/128,328

(22) PCT Filed: Jan. 22, 2009
(86) PCT No.: PCT/EP2009/050712

§ 371 Date: Jul. 27, 2011

(30) Foreign Application Priority Data
Nov. 7, 2008 (EP) 08105750.7
Jan. 7, 2009 (EP) 09100020.8

(51) Int. Cl. H04L 12/26

(52) U.S. Cl. 370/252

(57) ABSTRACT

An interconnection assembly for connecting a first communication network to a second communication network includes a first network device of the first communication network for selectively transmitting data packets to a second network device of the second communication network and a third network device of the first communication network for alternatively transmitting the data packets to the second network device of the second communication network depending on a status information made available to the third network device.

This application relates to communication packet networks and to Carrier Ethernet services that are delivered over interconnected packet networks.

The interconnected packet networks can comprise, for example, a customer network together with a service provider's network, two service providers' networks that are interconnected, or two internal networks belonging to a major service provider. An end-to-end service connection can span several such interconnected packet networks.

Each interconnected packet network can deploy different packet transport technology to deliver Carrier Ethernet services. Metro Ethernet Forum describes the Carrier Ethernet services in website, http://metroethernetforum.org. The interfaces used to interconnect the packet networks are based on IEEE (Institute of Electrical and Electronics Engineers) 802.3 MAC (media access control). The packets that are transmitted over the interfaces using Ethernet frames, as described in IEEE 802.3 or IEEE 802.1 document. The Ethernet frames may be transported using several transport technologies, such as ETH (Ethernet), GFP (Generic Framing Procedure), and WDM (Wavelength Division Multiplexing), or ETH and ETY (Ethernet Physical Layer).

Reliability, in terms of quality and availability, is believed to be a key attribute of the Carrier Ethernet service. Service guarantees or promises in the form of SLAB (Service Level Agreement) require a resilient network that rapidly detects facility failures or degradation, and restores network operation in accordance with the terms of the SLA. The facility can refer to a network interface or a network node.

Several mechanisms can be used to handle single point of failure at a zone that interconnects the packet networks. The single point of failure refers to a part of a network, wherein the network stops working when the part stops operating.

A Link Aggregation (LAG), as specified in IEEE 802.3ad provides link-level protection between two nodes. A protection mechanism bundles multiple physical links between two nodes into a single, aggregated, logical link. The logical link has greater capacity. When one or more physical links of the aggregated link fail, traffic from the failed physical link is redirected to the other physical link in the aggregation.

This redundancy mechanism protects against link failure, and does not protect against a failure of one of the nodes that resides in an edge of the aggregated logical link. In other words, the node represents a single point of failure, and if a node fails, the traffic is not delivered.

In addition, Link Aggregation Control Protocol (LACP) transmits no more than ten frames in any one-second period. This results in a recovery time that is in the order of a second. This may affect the SLA that is promised to an end user in terms of quality and of availability.

Multi Device Link Aggregation (MDLA), as specified in US 20030061533 A1 that is published on Mar. 27, 2003, enhances redundancy mechanism provided by the LAG, by splitting aggregated links, so that a LAG device is connected, by dual homing, to two independent nodes called MDLA devices. The two MDLA devices are connected via an MDLA internal link over which the two MDLA devices exchange information. This allows the two MDLA devices to detect a common LAG device, and to emulate a single device towards the LAG partner device. In addition to the link-level protection provided by the LAG, traffic from the associated aggregated links to a failed MDLA device is automatically redirected to the other MDLA device, in the event that one of the MDLA devices fails.

The associated Link Aggregation Control Protocol (LACP), which among other things detects link failure, requires a lengthy recovery time. The LAG device can represent a single point of failure. The two MDLA devices must be connected by an additional internal link that consumes a port on each of the MDLA devices for control communication purposes.

Split Multi Chassis LAG (SMLT), as specified in U.S. Pat. No. 7,173,934 B2, which is published on Feb. 6, 2007, provides a multi-link trunk from one client device to two aggregation devices. The aggregation devices work in conjunction with one another and appear to the client device as a single device. The aggregation devices exchange operational information and data packets over inter-device communication ports. One aggregation device can restore a failure of the other aggregation devices.

As with the MDLA, the client device in SMLT represents a single point of failure. Moreover, it requires a dedicated link between the two SMLT aggregation devices that may consume an additional port in each of the SMLT aggregation devices.

Multi Chassis LAG (MC-LAG), as described in a white paper by Alcatel Lucent allows a LAG to be defined between an Ethernet edge device and two Provider Edge (PE) devices that appear as a single device to the Ethernet edge device.

The MC-LAG manages the available LAG links in “active” or “standby” mode, so that only links from one of the PE devices are active at any one time to and from the Ethernet edge device. A MC-LAG control protocol runs between the two PE devices. This control protocol is an IP (Internet Protocol)-based protocol that synchronizes the LAG state between the two PE devices. For this reason, the PE devices are connected but not necessarily directly connected.

The Ethernet edge device represents a single point of failure. The MC-LAG uses a LACP (Link Aggregation Control protocol) protocol that results in a recovery time that is in the order of one second. The standby links are not in use when there is no failure. Unused capacity is often costly. The control protocol is IP-based and requires the support of IP functionality.

Multi-chassis emulated switch, as specified in US 20080089247 A1, which is published on Apr. 17, 2008, provides interfaces between multiple edge switches and a device supporting a spanning tree, so that the multiple switches are treated as a single emulated switch to an attached client. This emulated switch effectively enables two different views to the two different sides. Frames destined to an emulated link may take any of links from any of the physical switches, thereby enabling effective load balancing for frames travelling from the attached client. Meanwhile, the client does not recognize an illegal loop in its connection to the two different edge switches, as it views the two links as a single logical EtherChannel (LAG).

The switch uses STP (Spanning Tree Protocol) that includes Rapid STP or Multiple STP to redirect the traffic. STP convergence time is inadequate for Carrier Ethernet networks. The switch represents a single point of failure on the connecting side.

It is believed that network survivability plays a critical factor in the delivery of reliable services. The network survivability refers to capability of a communication network to maintain service continuity in presence of faults within the communication network. The communication network provides transmission service of data packets for users of the communication network.

The application provides a method of transmitting data packets of a first communication network to a second communication network. The first communication network and the second communication network provide data packets communication services for its users.

The first communication network comprises a master network device that is communicatively connected to a slave network device of the second communication network. The communicatively connection provides a channel for communicating or transmitting the data packets. A deputy network device of the first communication network is also communicatively connected to the slave network device.

The master network device or the deputy network device can receive the data packets from the first communication network and then transmits the data packets to the slave network device. The slave network device then transmits the received data packets to the other network nodes of the second communication network.

The transmission of the data packets between the master network device and the slave network device and between the deputy network device and the slave network device uses Ethernet frames. The data packets allow a provision of Ethernet services for users of the first or second communication network.

The deputy network device acts to protect the transmission of the data packets from the master network device to the slave network device. In the event, the master network device is unable to transmit the data packets or is transmitting the data packets in a slow manner, the deputy network device can take over the role of the master network device. In this manner, the transmission of the data packets is protected in that the data packet transmission is not interrupted.

It is believed that a slave network device status can indicate a status of the master network device. The deputy network device can listen or monitor the status of the slave network device and use the monitored status to decide on taking over the transmission of the data packets. The slave node status may indicate that a data transmission service of the master network device is degrading or not working.

The method comprising the step of transmitting the data packets from the master network device to the slave network device. The slave network device also transmits operational status information of the slave network device to the deputy network device. The operational status information of the slave network device can reflect or show the operational status of the master network device. For example, the operational status information of the slave network device can show that it is not receiving the data packets from the master network device. This can indicate that the master network device is down and that the deputy network device should take over the role of the master network device to prevent a breakdown of transmission of the data packets.

The method includes the step of the deputy network device monitoring an operational status of the slave network device based on the transmitted operational status information of the slave network device. The deputy network device can then transmit the data packets to the slave network device when it detects or receives predetermined operational status information of the slave network device. The operational status information can indicate that the slave network device is active, that the master network device is down, or that the master network device is slow.

The slave network device can also transmit operational status information of the slave network device to the master network device. In a similar manner, the operational status information of the slave network device can provide operational status information of the deputy network device to the master network device.

The master network device can again transmit the data packets to the slave network device when it receives a predetermined operational status of the slave network device. The predetermined operational status can indicate that the deputy network device is going down and that the master network device should take over the transmission of data packets from the deputy network device. On the other hand, it can indicate that the master network device is now operational and that it wants to resume the role of data packet transmission.

According to the application, a method of operating a master network device is provided. The master network device transmits data packets from a first communication network to a second communication network.

The master network device is communicatively connected to the first communication network and to a slave network device of the second communication network.

The method comprises the step of transmitting master network device operational status information to the slave network device.

The slave network device can also transmit slave network device operational status information to the master network device.

The master network device can stop a transmission of the data packets to the slave network device when it receives a predetermined operational status of the slave network device. The predetermined operational status can indicate that the deputy network device is ready to take over the transmission of the data packets and that the master network device should stop transmitting the data packets.

According to the application, a method of operating a slave network device is provided. The slave network device is used for receiving data packets from a first communication network.

The slave network device is communicatively connected to a second communication network, to a master network device of the first communication network, and to a deputy network device of the first communication network.

The method comprises the step of the slave network device receiving operational status information of the master network device. The slave network device then transmits operational status information of the slave network device to the deputy network device.

The slave network device then adapts an operational mode of the slave network device using a predetermined operational status of the master network device. The slave network device can adapt or change its operational mode based on the operational mode or status of the master network device. In this manner, it works in co-operation with the master network device.

The application also provides a method of operating a deputy network device. The deputy network device transmits data packets from a first communication network to a second communication network.

The deputy network device is communicatively connected to the first communication network and to a slave network device of the second communication network whilst the slave network device is connected to a master network device of the first communication network.

The method comprises the step of the deputy network device receiving operational status information of the slave network device from the slave network device.

The deputy network device transmits the data packets to the slave network device when it detects a predetermined operational status of the slave network device. The predetermined operational status can indicate that the slave network device is in an active mode or that the master network device is in a standby mode.

The deputy network device can monitor an operational status of the slave network device based on the transmitted operational status information. The deputy network device can then stop transmitting the data packets to the slave network device when it detects a predetermined operational status of the slave network device. For example, this step can be performed in the event that the master network device is operational and that the master network device is ready to resume the role of data packet transmission.

According to the application, a network interconnection assembly is provided. The network interconnection assembly is used for transmitting data packets from a first communication network to a second communication network.

The network interconnection assembly comprises a master network device of the first communication network for transmitting the data packets to a slave network device of the second communication network and a deputy network device of the first communication network for transmitting data packets to the slave network device of the second communication network.

The master network device comprises a master network device port for transmitting the data packets to the slave network device. The master network device also comprises a master network device controller.

The slave network device comprises a slave network device port and a slave network device controller for sending slave network device operational status information to the deputy network device.

The deputy network device comprises a deputy network device port for transmitting the data packets to the slave network device, and a deputy network device controller for ruling, determining, or controlling the transmission of the data packets to the slave network device based on the operational status information of the slave network device. The operational status information of the slave network device can indicate that the slave network device is active, that the master network device is down, or that the master network device is operating slowly.

The slave network device controller can transmit operational status information of the slave network device to the master network device. The master network device port can again transmit the data packets to the slave network device when it receives a predetermined operational status of the slave network device.

The application also provides a master network device for transmitting data packets from a first communication network to a second communication network. The master network device is communicatively connected to the first communication network and to a slave network device of the second communication network.

The master network device comprises a master network device port for transmitting and the data packets to the slave network device. The master network device also comprises a master network device controller for transmitting master network device operational status information to the slave network device.

The application also provides a slave network device for receiving data packets from a first communication network. The slave network device is communicatively connected to a second communication network, to a master network device of the first communication network, and to a deputy network device of the first communication network.

The slave network device comprises a slave network device port for receiving operational status information of the master network device. The slave network device also includes a slave network device controller for transmitting operational status information of the slave network device to the deputy network device. The slave network device controller also adapts an operational mode of the slave network device using a predetermined operational status of the master network device.

According to the application, a deputy network device for transmitting data packets is provided. The data packets is transmitted from a first communication network to a second communication network.

The deputy network device is communicatively connected to the first communication network and to a slave network device of the second communication network. The slave network device of the second communication network is also connected to a master network device of the first communication network.

The deputy network device comprises a deputy network device port for receiving slave network device operational status information from the slave network device and for transmitting the data packets to the slave network device.

The deputy network device also includes a deputy network device controller for ruling the transmission of the data packets based on an operational status of the slave network device within a period.

The deputy network device controller can monitor an operational status of the slave network device based on the transmitted operational status information and then stops transmission of the data packets to the slave network device based on a predetermined operational status of the slave network device. The operational status can indicate that the master network device is now operational.

The application provides a further method of transmitting data packets of a first communication network to a second communication network.

The first communication network comprises a master network device that is communicatively connected to a first slave network device of the second communication network and to a second slave network device of the second communication network.

It is believed that the second slave network device can protect the transmission of the data packets to the first network device. In the event, that the first slave network device cannot receive the data packets, the master network device can transmit the data packets to the second slave network device. In this way, the transmission of the data packets from the first communication network to the second communication network is not interrupted.

The method comprises the step of transmitting the data packets from the master network device to the first slave network device. The first slave network device transmits operational status information of the first slave network device to the master network device. The master network device can use the operational status information of the first slave network device to rule or decide on the data packet transmission. For example, the operational status information can indicate that the first slave network device is working slowly or that the first slave network device needs to shut down for maintenance.

The master network device can then transmit the data packets to the second slave network device when it receives first slave network device predetermined operational status information.

The master network device may stop transmitting data packets to the first slave network while it transmits the data packets to the second slave network device. In a special case, the master network device may continue transmitting the data packets to both the first slave network and the second slave network device.

The master network device can resume transmitting the data packets to the first slave network device when it receives a first slave network device predetermined operational status. The first slave network device predetermined operational status can indicate that the first slave network device is now working and that it can receive the data packets.

The first communication network can further comprise a deputy network device that is communicatively connected to the first slave network device of the second communication network and to the second slave network device of the second communication network.

It is believed that the deputy network device can take over the role of the master network device when the master network device is not working properly or is working slowly. In doing this, the deputy network device provides protection for the transmission of the data packets from the first communication network to the second communication network.

The method can comprise the step of the first slave network device transmitting the operational status information of the first slave network device to the deputy network device.

The deputy network device can transmit the data packets to the first slave network device when it receives first slave network device predetermined operational status information. The predetermined operational status information is used as a trigger to request or demand that the deputy network device takes over the role of transmitting the data packets.

The application also provides a further method of operating a master network device for transmitting data packets from a first communication network to a second communication network.

The master network device is communicatively connected to the first communication network, to a first slave network device of the second communication network, and to a second slave network device of the second communication network.

The method comprises the step of transmitting the data packets from the master network device to the first slave network device. The master network device transmits the data packets to the second slave network device when it detects or receives a predetermined operational status of the first slave network device. The master network device does not transmit the data packets to the first slave network device while it transmits the data packets to the second slave network device. In a special case, the master network device transmits the data packets to both the first slave network and the second slave network device.

The master network device may resume transmission of the data packets to the first slave network device when it receives a predetermined operational status of the first slave network device.

The application provides a further network interconnection assembly for transmitting data packets of a first communication network to a second communication network.

The network interconnection assembly comprises a master network device of the first communication network that is communicatively connected to a first slave network device of the second communication network and to a second slave network device of the second communication network.

The master network device comprises a first master network device port for transmitting data packets to the first slave network device and a second master network device port for transmitting the data packets to the second slave network device

The master network device also includes a master network device controller for ruling the transmission of the second master network device port based on operational status information of the first slave network device. For example, the operational status information can indicate that the first slave network device is going to shut down for administrative purpose. The master network device controller can then react accordingly.

The first slave network device comprises a first slave network device controller for transmitting the operational status information of the first slave network device to the master network device.

The master network device may stop transmitting the data packets to the first slave network device while it transmits the data packets to the second slave network device. In other words, there is no duplication of data packet transmission.

The first communication network can include a deputy network device that is communicatively connected to the first slave network device of the second communication network and to the second slave network device of the second communication network.

The first slave network device controller transmits the operational status information of the first slave network device to the deputy network device.

The deputy network device comprises a deputy network device port and a deputy network device controller. The deputy network device port is intended for transmitting the data packets to the first slave network device. The deputy network device controller is intended for ruling or governing the transmission of the data packets of the deputy network device port based on operational status information of the first slave network device. The operation status information can indicate that the first slave network is going to shut down for repair or maintenance.

The application also provides a further master network device for transmitting data packets from a first communication network to a second communication network.

The master network device is communicatively connected to the first communication network, to a first slave network device of the second communication network, and to a second slave network device of the second communication network

The master network device comprises a first master network device port, a second master network device port, and a master network device controller. The first master network device port is intended for transmitting the data packets to the first slave network device whilst the second master network device port is intended for transmitting the data packets to the second slave network device. The master network device controller is intended for ruling the transmission of data packets based on an operational status of the first slave network device.

The application provides a method of transmitting data packets of a first communication network to a second communication network.

The first communication network comprises a master network device that is communicatively connected to a slave network device of the second communication network and a deputy network device that is communicatively connected to the slave network device.

It is believed that the slave network device can transfer operational status information of the master network device to the deputy network device. When the deputy network device does not receive the operational status information for a period, it may assume that the master network device is down. The deputy network device can then react by taking over a task of data packet transmission. In this manner, the deputy network device provides protection for transmitting of the data packets to the slave network device.

The method comprises the step of transmitting the data packets and master network device operational status information from the master network device to the slave network device. The slave network device then transmits the master network device operational status information to the deputy network device.

The deputy network device monitors master network device operational status using the transmitted master network device operational status information. When the deputy network device does not receive or detect master network device predetermined operational status, the deputy network device transmits the data packets to the slave network device.

The slave network device can also transmit slave network device operational status information to the master network device. The master network device can again transmit the data packets to the slave network device when it receives a predetermined operational status of the slave network device. The master network device may be down for a period and later it is working again. In this manner, the slave network device can inform the master network device to start data packet transmission after the master network device is working again. This allows synchronisation of events to prevent duplication of data packet transfer.

The application also provides a further method of operating a slave network device for receiving data packets from a first communication network.

The slave network device is communicatively connected to a second communication network, to a master network device of the first communication network, and to a deputy network device of the first communication network.

The method comprises the step of the slave network device receiving master network device operational status information, and transmitting the received master network device operational status information to the deputy network device. In this way, the deputy network device is aware of operational status of the master network device and it can react appropriately.

The application also provides a further method of operating a deputy network device for transmitting data packets from a first communication network to a second communication network.

The deputy network device is communicatively connected to the first communication network and to a slave network device of the second communication network. The slave network device of the second communication network is further connected to a master network device of the first communication network.

The method comprises the step of the deputy network device receiving operational status information of the master network device from the slave network device. The deputy network device then transmits the data packets to the slave network device when it does not receive or detect a predetermined operational status of the master network device.

The deputy network device can monitor an operational status of the slave network device based on the transmitted operational status information. Then, the deputy network device stops transmission of the data packets to the slave network device when it detects a predetermined operational status of the slave network device. This can happen when the master device node is now working and the deputy network device transfers the task of data packet transmission to the master device.

The application provides a further network interconnection assembly for transmitting data packets of a first communication network to a second communication network.

The network interconnection assembly comprises a master network device of the first communication network that is communicatively connected to a slave network device of the second communication network and a deputy network device of the first communication network that is communicatively connected to the slave network device.

The master network device comprises a master network device port for transmitting the data packets and for transmitting operational status information of the master network device to the slave network device.

The slave network device comprises a slave network device port for transmitting the operational status information of the master network device to the deputy network device

The deputy network device comprises a deputy network device port and a deputy network device controller. The deputy network device port is used for transmitting the data packets to the slave network device whilst the deputy network device controller is intended for monitoring operational status of the master network device based on the transmitted operational status information of the master network device. The deputy network device controller is also used for ruling a transmission of the data packets of the deputy network port based on the operational status of the master network device. The ruling can be based on not receiving the operational status of the master network device.

In some cases, the slave network device port can transmit operational status information of the slave network device to the master network device. The master network device can comprise a master network device controller for ruling the transmission of the data packet to the slave network device based on the slave network device operational status.

The application also provides a further slave network device for receiving data packets from a first communication network.

The slave network device is communicatively connected to a second communication network, to a master network device of the first communication network, and to a deputy network device of the first communication network.

The slave network device comprises a slave network device port for receiving operational status information of the master network device, and for transmitting the received operational status information of the master network device to the deputy network device. This transmission of the operational status information allows the deputy network to monitor operational status of the master network device.

According to the application, a further deputy network device is provided. The deputy network device is intended for transmitting data packets from a first communication network to a second communication network.

The deputy network device is communicatively connected to the first communication network and to a slave network device of the second communication network. The slave network device of the second communication network is also connected to a master network device of the first communication network.

The deputy network device comprises a deputy network device port and a deputy network device controller. The deputy network device port is used for receiving operational status information of the master network device from the slave network device. The deputy network device controller is intended for ruling a transmission of the data packets to the slave network device based on the operational status information of the master network device. The ruling can be based on not receiving the operational status information of the master network device within a period.

The deputy network device controller can monitor an operational status of the slave network device based on the transmitted operational status information. The deputy network device controller can rule the transmission of the data packets to the slave network device based on the monitored operational status of the slave network device.

The application provides a further method of transmitting data packets of a first communication network to a second communication network.

The first communication network comprises a master network device that is communicatively connected to a first slave network device of the second communication network and to a second slave network device of the second communication network.

It is believed that the first slave network device can provide its operational status information to the master network device. When the master network device does not receive the operational status information for a period, the master network device can assume that the first slave network device is not working and that the master network device can send the data packets to the second slave network device.

The method comprises the steps of transmitting data packets from the master network device to the first slave network device. The first slave network device also transmits operational status information of the first slave network device to the master network device. Then, the master network device transmits the data packets to the second slave network device when it does not receive a predetermined operational status of the first slave network device for a period.

The master network device can again transmit the data packets to the first slave network device when it receives a predetermined operational status of the first slave network device.

The master network device may stop transmitting the data packets to the second slave network device when it again transmits the data packets to the first slave network device.

The first communication network can comprise a deputy network device that is communicatively connected to the first slave network device of the second communication network and to the second slave network device of the second communication network.

The method can comprise the step of the first slave network device transmitting the first operational status information of the slave network device to the deputy network device. The deputy network device can transmit the data packets to the first slave network device when it receives predetermined operational status information of the first slave network device.

The application also provides a further method of operating a master network device for transmitting data packets from a first communication network to a second communication network.

The master network device is communicatively connected to the first communication network and to a first slave network device of the second communication network and to a second slave network device of the second communication network

The method comprises the steps of transmitting the data packets from the master network device to the first slave network device, and the master network device transmitting the data packets to the second slave network device when not receiving a predetermined operational status of the first slave network device.

The master network device can again transmit the data packets to the first slave network device when it receives a predetermined operational status of the first slave network device.

The application provides a further network interconnection assembly for transmitting data packets of a first communication network to a second communication network.

The network interconnection assembly comprises a master network device of the first communication network that is communicatively connected to a first slave network device of the second communication network and to a second slave network device of the second communication network.

The master network device comprises a first master network device port and a master network device controller. The first master network device port is intended for transmitting the data packets to the first slave network device. The master network device controller is intended for ruling the trans-mission of the data packets to the second slave network device when it does not receive a predetermined operational status of the first slave network device for a period.

The first slave network device comprises a first slave network device port for transmitting operational status information of the first slave network device to the master device network.

The master network device may stop transmitting the data packets to the first slave network device while it transmits the data packets to the second slave network device.

The master network device controller can also rule the trans-mission of the data packets to the first slave network device based on the predetermined operational status information of the first slave network device.

The master network device may stop transmitting the data packets to the second slave network device when it again transmits the data packets to the first slave network device.

In certain cases, transmission to both slave network devices is also possible.

The network interconnection assembly can comprise a deputy network device that is communicatively connected to the first slave network device of the second communication network and to the second slave network device of the second communication network.

The first slave network device port transmits the first slave network device operational status information to the deputy network device.

The deputy network device comprises a deputy network device port for transmitting the data packets to the first slave network device based on the operational status information of the first slave network device.

According to the application, a further master network device for transmitting data packets from a first communication network to a second communication network is provided.

The master network device is communicatively connected to the first communication network and to a first slave network device of the second communication network and to a second slave network device of the second communication network.

The master network device comprises a first master network device port and a second master network device port. The first master network device port is used for transmitting the data packets to the first slave network device. The second master network device port is intended for transmitting the data packets to the second slave network device when it does not receive a predetermined operational status of the first slave network device for a period.

The first master network device port can again transmit the data packets to the first slave network device when it receives a predetermined operational status of the first slave network device.

It is believed that a working condition of a communication link between a master network device and a slave network device can be monitored. A status of the working condition can be sent to a deputy network device. When the communication link has deteriorated or is not functioning, the deputy network device can decide to take over the role of the master network device to transmit the network information.

The application provides a method of transmitting data packets of a first communication network to a second communication network.

The first communication network comprises a master network device of the first communication network and a deputy network device of the first communication network. The master network device is physically connected to a slave network device of the second communication network via a master-slave link whilst the deputy network device is physically connected to the slave network device via a deputy-slave link.

It is believed the slave network device can monitor a physical value of the master-slave link. The physical value includes a voltage value, an electrical current value, or a reflection time of a signal pulse. The physical value can provide an indication of a working condition of the master-slave link. For example, the indication can point to an open-circuit condition. Based on the indication, the deputy network device can assume that the master network device is unable to deliver the data packets to the slave network device and that the deputy network device can take over the role of sending the data packets to the slave network device. In this way, the transmission of the data packets to the slave network device is protected.

The method comprises the step of transmitting the data packets from the master network device to the slave network device. The slave network device monitors an operational status of the master-slave link. The operational status is based on the physical value of the master-slave link. The slave network device also transmits operational status information of the master-slave link to the deputy network device. When the deputy network device detects certain master-slave link predetermined operational status information, it assumes the master-slave link is broken and it transmits the data packets to the slave network device.

The application provides a further a method of operating a slave network device for receiving data packets from a first communication network to a second communication network.

The slave network device of the second communication network is physically connected to a master network device of the first communication network via a master-slave link and to a deputy network device of the first communication network via a deputy-slave link.

The method comprises the step of the slave network device monitoring a master-slave link operational status and transmitting master-slave link operational status information to the deputy network device.

The application provides a further method of operating a deputy network device for transmitting data packets from a first communication network to a second communication network.

The deputy network device of the first communication network is physically connected to a slave network device of the second communication network via a deputy-slave link whilst the slave network device is further physically connected to a master network device of the first communication network via a master-slave link.

The method comprises the step of the deputy network device receiving an operational status information of the master-slave link from the slave network device.

The deputy network device transmits the data packets to the slave network device when it detects a predetermined operational status of the master-slave link.

The application provides a further a network interconnection assembly for transmitting data packets of a first communication network to a second communication network.

The network interconnection assembly comprises a master network device a master network device of the first communication network and deputy network device of the first communication network. The master network device is physically connected to a slave network device of the second communication network via a master-slave link whilst the deputy network device is physically connected to the slave network device via a deputy-slave link.

The master network device comprises a master network device port for transmitting the data packets to the slave network device.

The slave network device comprises a slave network device controller for monitoring a master-slave link operational status and a slave network device port for transmitting master-slave link operational status information to the deputy network device.

The deputy network device comprises a deputy network device port for transmitting the data packets to the slave network device and a deputy network device controller for ruling the transmission of the data packets using master-slave link predetermined operational status information.

The application provides a further a slave network device for receiving data packets from a first communication network to a second communication network.

The slave network device is physically connected to the second communication network to a master network device of the first communication network via a master-slave link and to a deputy network device of the first communication network via a deputy-slave link.

The slave network device comprises a slave network device controller for monitoring a master-slave link operational status and for transmitting master-slave link operational status information to the deputy network device.

The application provides a further a deputy network device for transmitting data packets from a first communication network to a second communication network.

The deputy network device is physically connected to the first communication network and to a slave network device of the second communication network via a deputy-slave link. The slave network device of the second communication network is further physically connected to a master network device of the first communication network via a master-slave link.

The deputy network device comprises a deputy network device port for transmitting the data packets to the slave network device and a deputy network device controller for ruling the transmission of the data packets using master-slave link operational status information from the slave network device.

The application provides a method of transmitting data packets of a first communication network to a second communication network.

It is believed that a master network device of the first communication network can monitor a physical value of a communication link between the master network device and a slave network device of the second communication network. The physical value can be a voltage, an electrical current, or signal reflection time. For example, the communication link between the slave network device and the master network device may be cut.

Base on the physical value, the master network device can determine a working condition of the physical link. The master network device can then used the physical value to rule on its transmission of data packets to a slave network device of the second communication network. It may decide to stop transmitting the data packets to the slave network device and transmits the data packets to another slave network device.

This method allows the master network device to respond automatically to certain physical conditions of the physical link and thus increase reliability of data packet transmission.

The master network device of the first communication network is physically connected to a first slave network device of the second communication network and to a second slave network device of the second communication network.

The method comprises the step of transmitting the data packets from the master network device to the first slave network device and of monitoring an operational status of the first slave-master link. The operational status can be derived from a physical value, such as voltage or an electrical current, of the first slave-master link.

When a first slave-master link predetermined operational status is detected, the master network device transmits the data packets to the second slave network device.

The master network device can transmit the data packets to the first slave network device when it detects a further first slave-master link predetermined operational status.

The application provides a further method of operating a master network device for transmitting data packets from a first communication network to a second communication network.

The master network device of the first communication network is physically connected to a first slave network device of the second communication network and to a second slave network device of the second communication network.

The method comprises the step of transmitting the data packets from the master network device to the first slave network device and of monitoring an operational status of the first slave-master link. When the master network device detects a predetermined operational status of the first slave-master link, the master network device transmits the data packets to the second slave network device and stops transmitting the data packets the first slave network device.

The master network device can transmit the data packets to the first slave network device when it detects a further first slave-master link predetermined operational status.

The application provides a network interconnection assembly for transmitting data packets of a first communication network to a second communication network.

The network interconnection assembly comprises a master network device that is physically connected to a first slave network device of the second communication network via a first slave-master link and to a second slave network device of the second communication network via a second slave-master link.

The master network device comprises a first master network device port, a second master network port as well as a master network device controller.

The first master network device port is used for transmitting the data packets to the first slave network device whilst second master network device port is used for transmitting the data packets to the second slave network device.

The master network device controller is used for monitoring a first slave-master link operational status and for ruling the transmission of the data packets using first slave-master link operational status information.

The application provides a master network device for transmitting data packets from a first communication network to a second communication network.

The master network device of the first communication network is physically connected to a first slave network device of the second communication network and to a second slave network device of the second communication network.

The master network device comprises a first master network device port, a second master network device port and a master network device controller.

The first master network device port is used for transmitting the data packets from the master network device to the first slave network device. The second master network device port is intended for transmitting the data packets from the master network device to the second slave network device.

The master network device controller is used for monitoring an operational status of the first slave-master link and for ruling the transmission of the data packets using operational status information of the first slave-master link.

The application also provides a network node for transmitting data packets of a first communication network to a second communication network. The network node is able to send, receive, or forward data packets over a communications channel or link. The network node can include a switch or router. The network node comprises a master network device.

In another aspect of the application, the application provides a further network node for transmitting data packets of a first communication network to a second communication network. The further network node comprises a slave network device.

In a further aspect of the application, the application provides a further network node for transmitting data packets of a first communication network to a second communication network. The further network node comprises a deputy network device.

The master network device, the slave network device, or the deputy network device is configured for a particular VLAN (Virtual Local Area Network) and it works independently of the other VLANs.

The network node can comprise one or more network devices, wherein the network devices are configured for one or more VLANs. Every VLAN and the network devices support the VLAN can work independently of other VLANs.

The application also provides a computer program for executing one of the above-mentioned methods.

In accordance with the application, a storage medium, such as a ROM (Read Only Memory), for holding the computer program is also provided.

The application also provides a network node computer system. The network node computer system can be part of a switch or a hub. The network node computer system is intended for controlling a network node. The network node computer system comprises a processor that is connected to a memory and to one or more ports. The memory can include a storage medium that comprises a ROM.

The network node computer system controls the handling of data packets at the ports. A computer program for executing one of the above-mentioned methods is loaded into the memory. The network node can comprise a switch or a router.

In particular, survivability of a zone that interconnects communication networks is an important factor. The interconnected zone comprises network nodes that reside in edges of the communication network. The network edge nodes of one communication network send data packets to network edge nodes of another communication network. The exchanges are via network interfaces of the network edge nodes. In other words, the network interfaces act as interconnections between attached communication networks.

The mechanism described is this application is used to protect network traffic flows in an interconnected zone. The network traffic flow enables transmission of Carrier Ethernet services over the interconnected zone. The Carrier Ethernet provides enhancement to Ethernet protocol and it enables communication network providers to provide Ethernet services to its users.

The interconnected zone can have a “1×2 Attached” construction or a “2×2 Attached” construction.

The “1×2 Attached” interconnected zone comprises a first node of a first communication network that is attached to a second node of a second communication network and to a third node of the second communication network.

The first node, the second node, and the third node have node interfaces. The node interfaces are intended for transmitting the network flow to other node interfaces. The node interfaces comprises ports that are connected to ports of other nodes. For example, the node interfaces of the first node and of the second node transmits the network traffic flow to the node interface of the third node.

The first node, the second node, and the third node also have network interfaces. The network interfaces are intended for receiving the network traffic from the communication network and for sending the network traffic to the communication network. For example, the network interfaces of the first node and the second node receives the network traffic from the first communication network and sends the network traffic to the first communication network. Similarly, the network interface of the third node receives the network traffic from the second communication network and sends the network traffic to the second communication network.

A mechanism exists in the “1×2 Attached” interconnected zone to transmit Ethernet traffic over the interconnected zone via the first node to the second node or to the third node. The Ethernet traffic carries Carrier Ethernet services in a reliable way.

The “2×2 Attached” interconnected zone comprises the “1×2 Attached” interconnected zone with a fourth node that resides in the first communication network. The fourth node is attached to the second node and to the third node. The fourth node also has a node interface and a network interface.

Each node of the communication network is attached to the two other nodes of the attached communication network. Each node uses two interfaces for each traffic flow. The network traffic carries Carrier Ethernet services in a reliable way without a single point of failure or degradation via interfaces.

The network interfaces are intended for receiving the network traffic from the first or the second communication network and for sending the network traffic to the first or the second communication network.

The application provides an interconnected zone between packet networks. The interconnected zone is equipped with a mechanism that is capable of rapidly detecting a failure or facility degradation of the node or of the interface in the interconnected zone, and of restoring Ethernet traffic without affecting communication service that is provided to an end user for complying with reliability requirements of Carrier Ethernet services. The mechanism also provides a means to avoid a potential single point failure or a single point of facility degradation of the node or of the interface.

The packet network may rely on a different packet technology, which provides its own mechanism or mechanisms to ensure network survivability. The packet technology includes, but is not limited to, bridged Ethernet, Traffic Engineered Ethernet, L2 (Layer 2)-MPLS (Multiprotocol Label Switching), and MPLS-TP (Transport Profile).

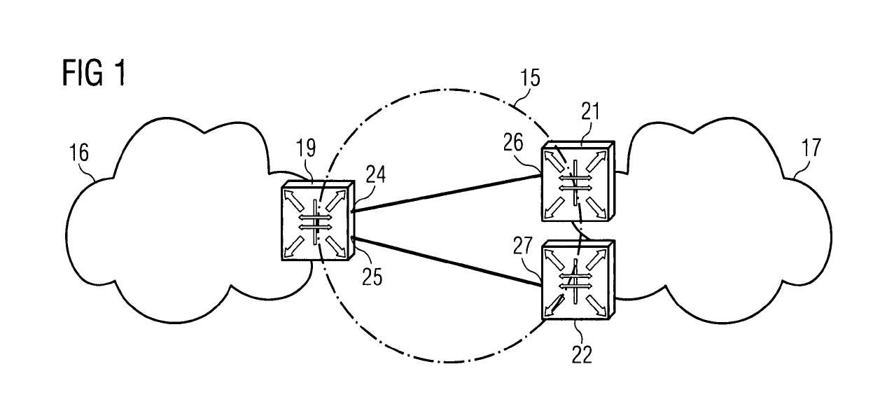

FIG. 1 illustrates a “1×2 Attached” interconnected zone,

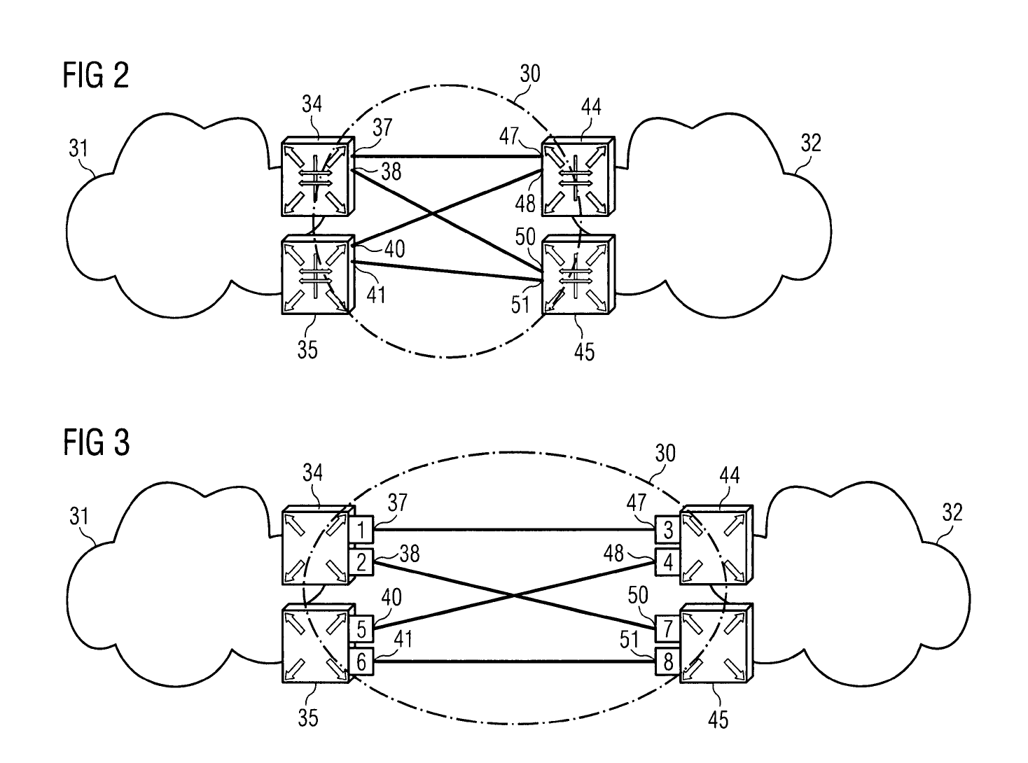

FIG. 2 illustrates a “2×2 Attached” interconnected zone,

FIG. 3 illustrates the interconnected zone with a protected VLAN (Virtual Local Area Network) of FIG. 2,

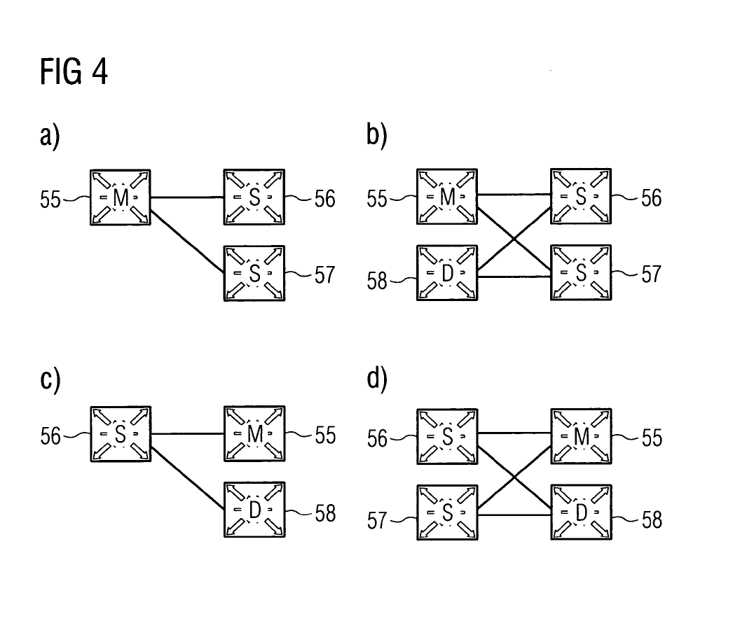

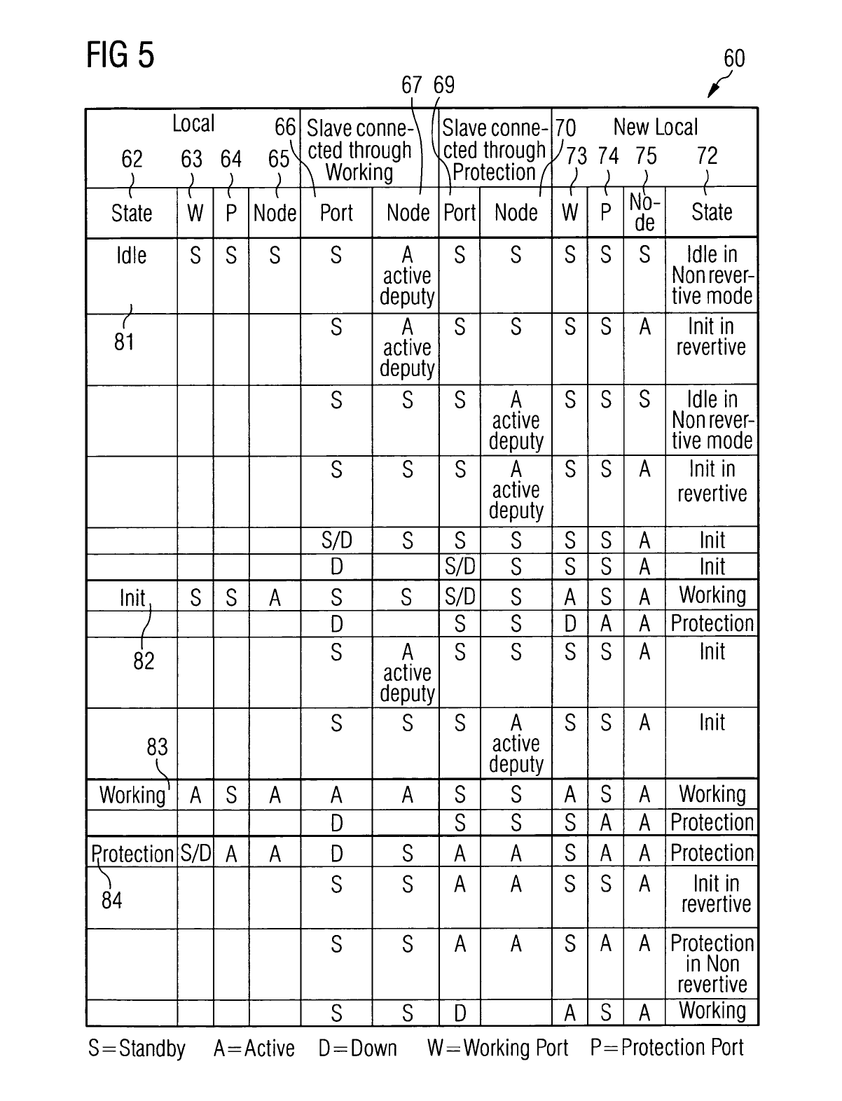

FIG. 4 illustrates node functions of the interconnected zone of FIG. 1 and FIG. 2,

FIG. 5 illustrates a table of a Master State Machine of FIG. 1 and FIG. 2,

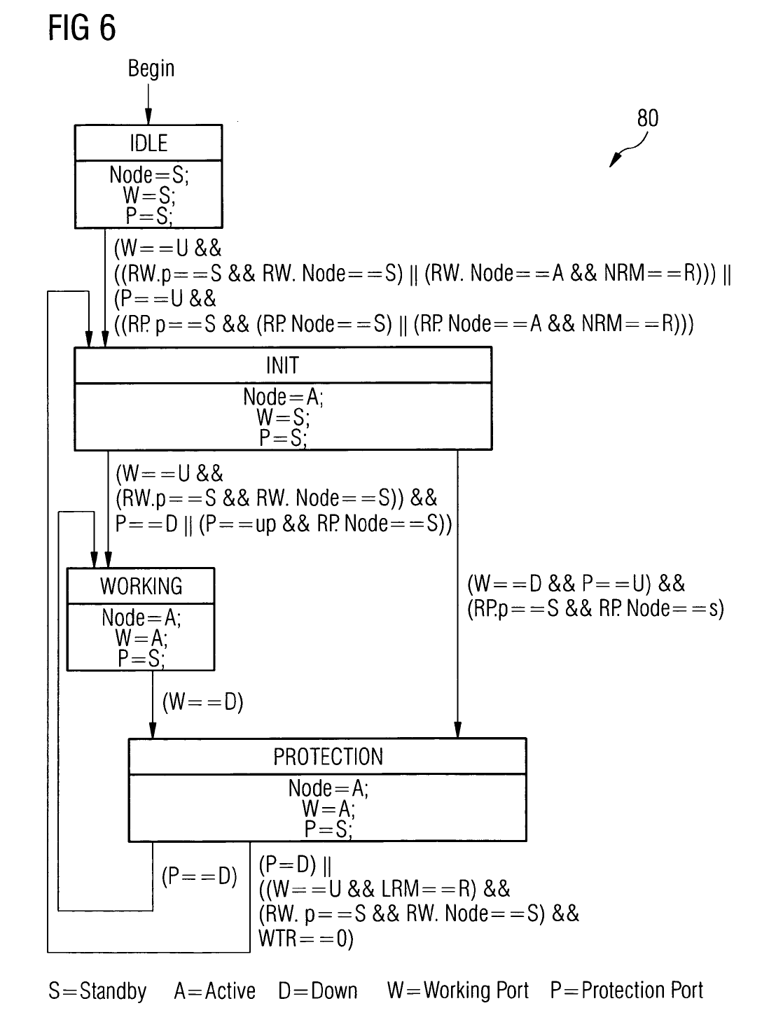

FIG. 6 illustrates a state flow chart of the Master State Machine of FIG. 5,

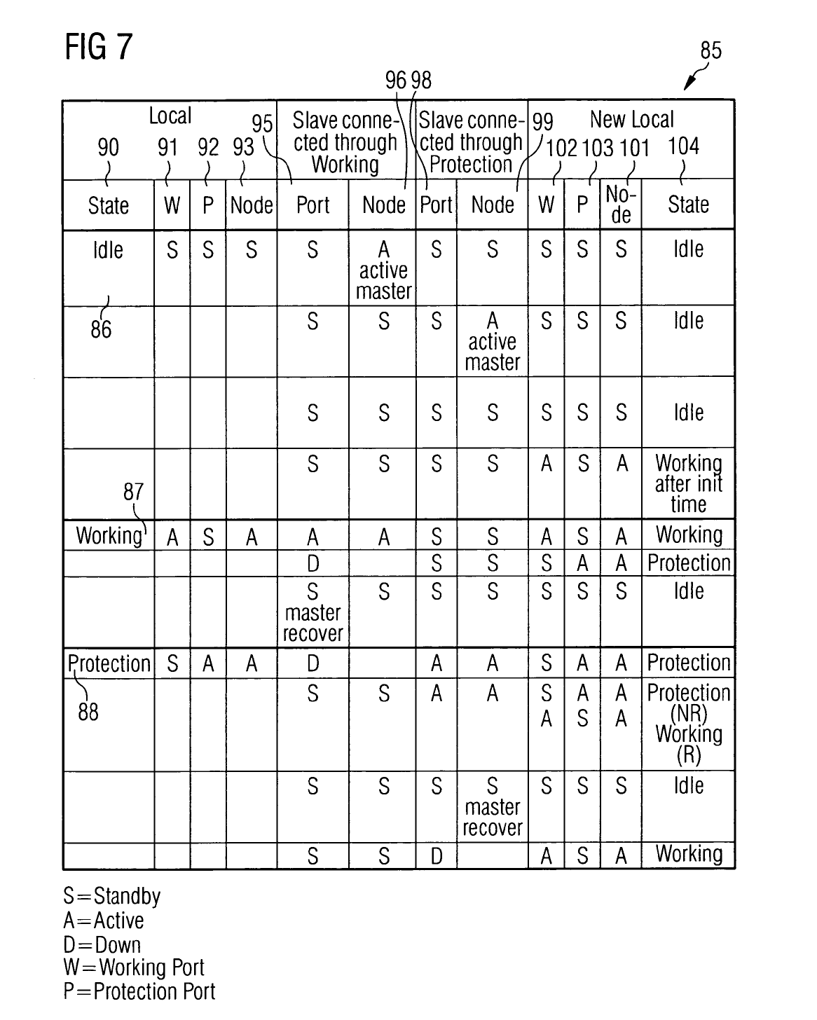

FIG. 7 illustrates a table of a Deputy State Machine of FIG. 2,

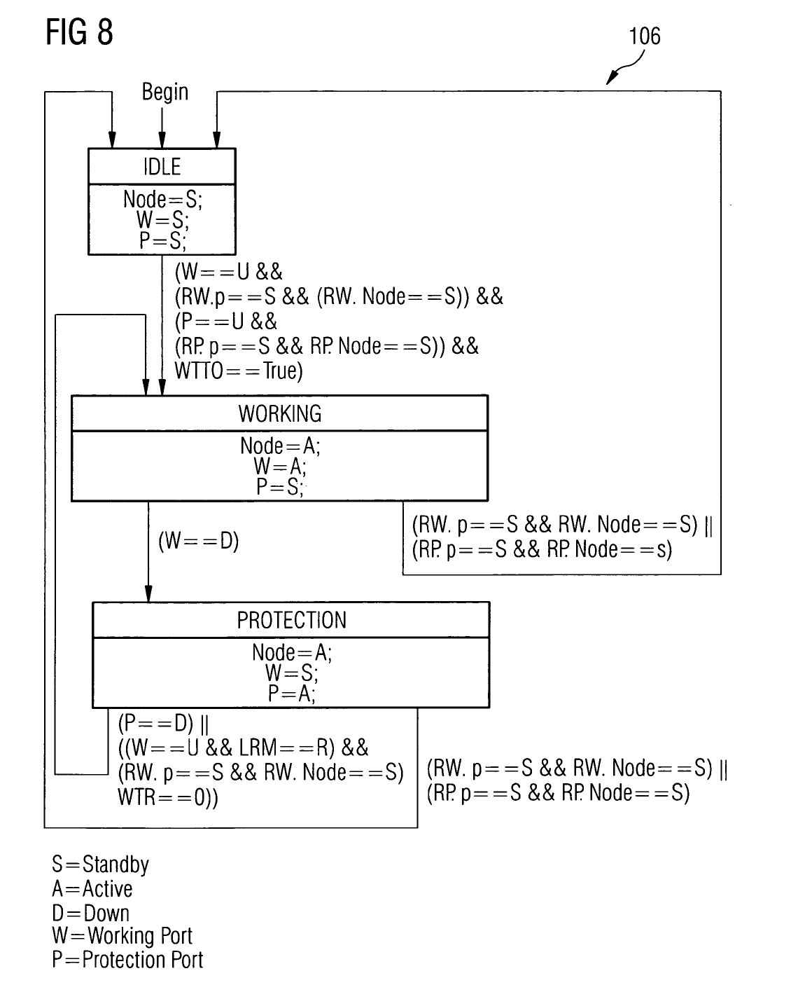

FIG. 8 illustrates a state flow chart of the Deputy State Machine of FIG. 7,

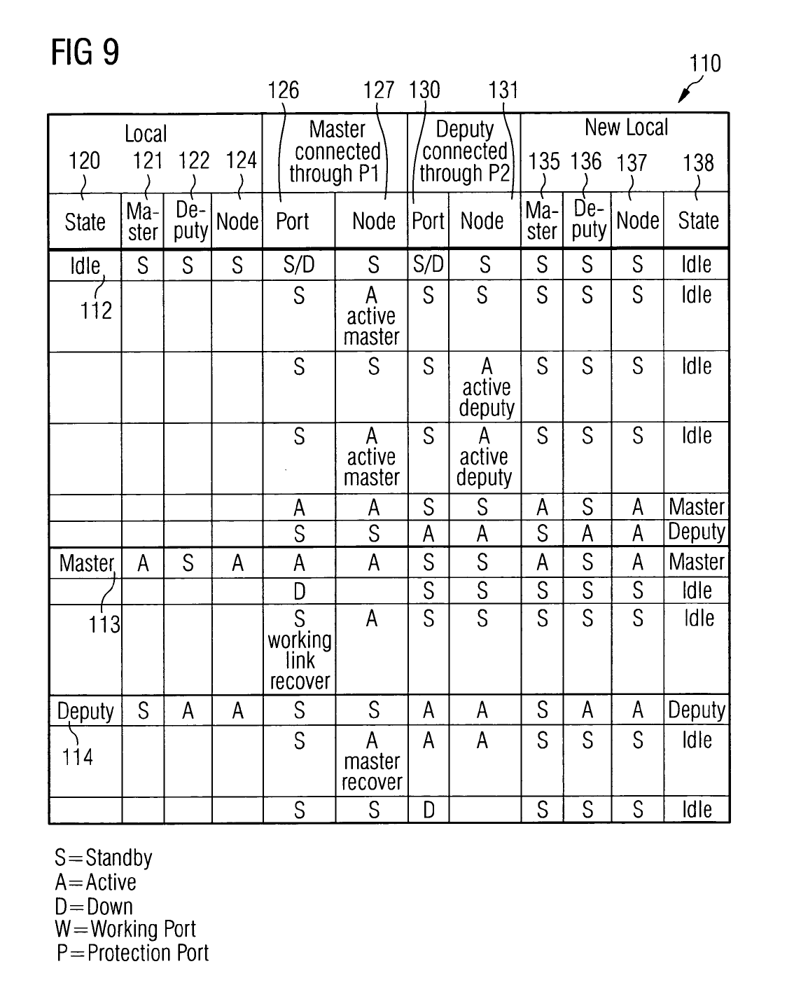

FIG. 9 illustrates a table of a Slave State Machine of FIG. 1 and FIG. 2,

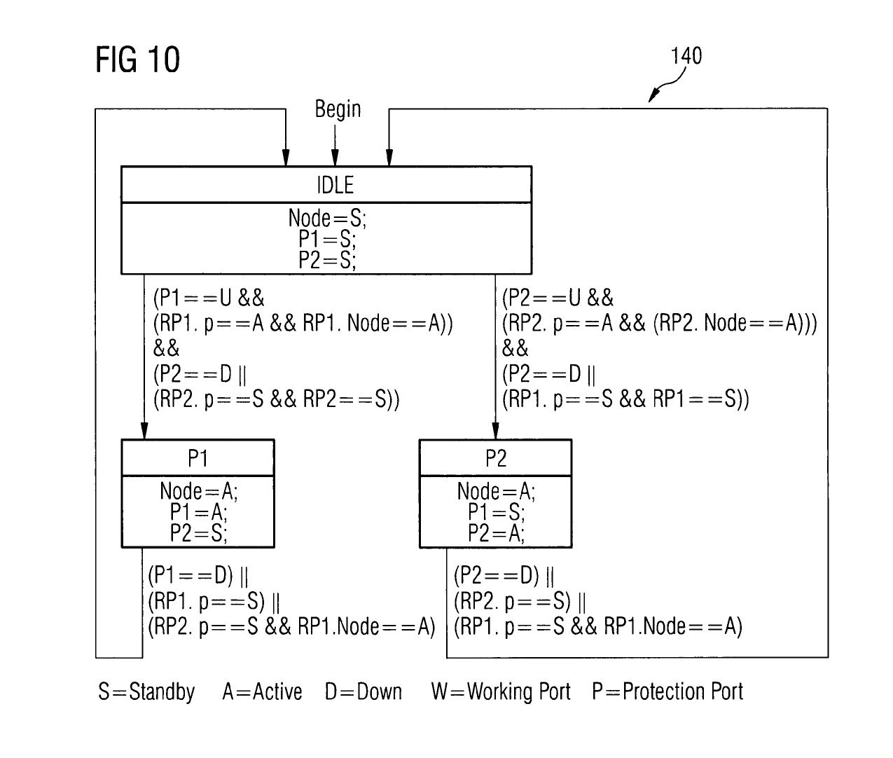

FIG. 10 illustrates a state flow chart of the Slave State Machine of FIG. 9,

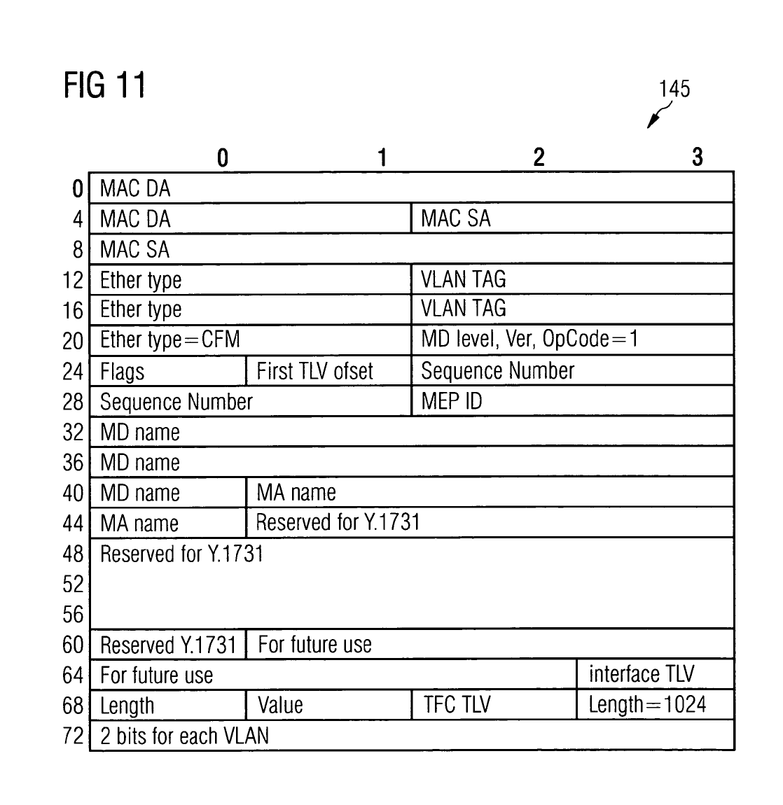

FIG. 11 illustrates a TFC (Traffic Forwarding Controller) TLV (Type/Length/Value) structure of FIG. 1 and FIG. 2,

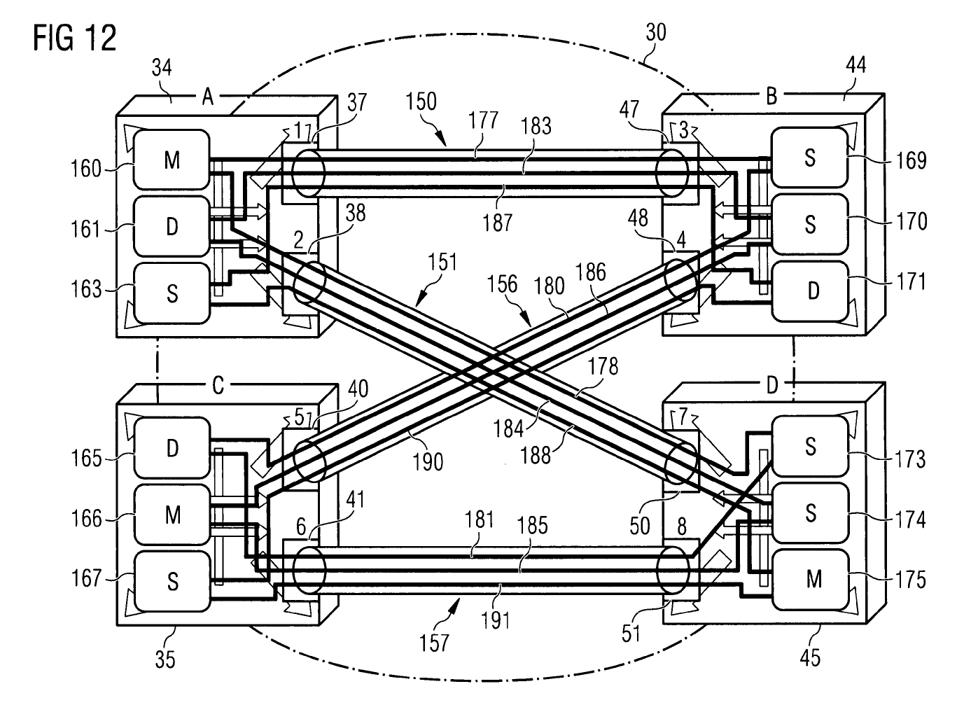

FIG. 12 illustrates the interconnected zone of FIG. 3 with functional elements of several VLANs (Virtual Local Area Network),

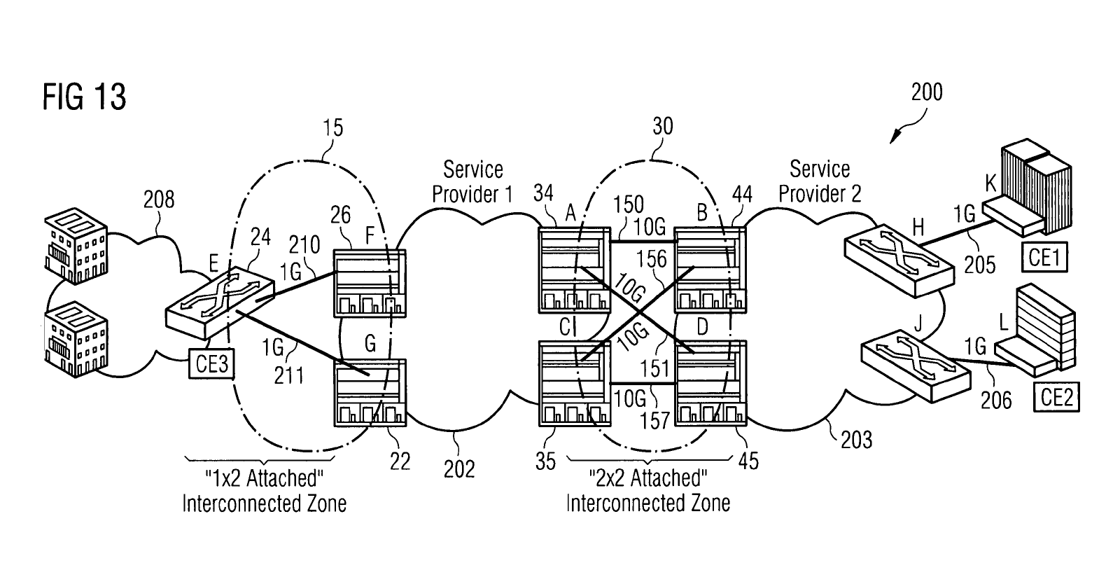

FIG. 13 illustrates an end-to-end connectivity using switches for delivery of network services,

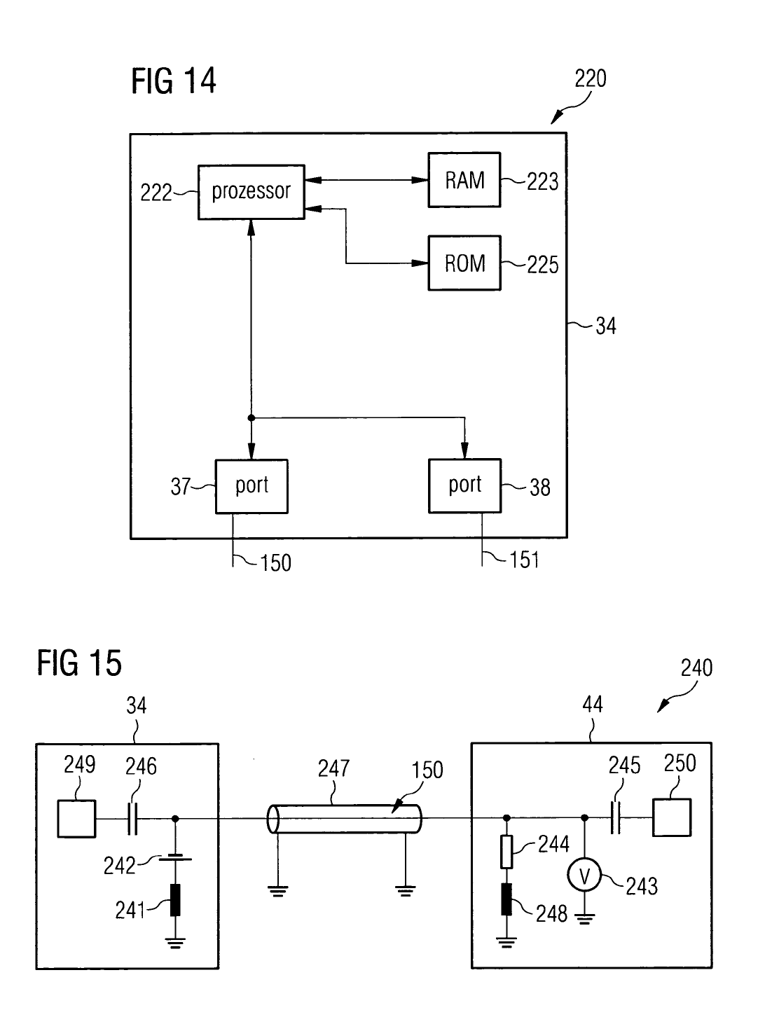

FIG. 14 illustrates a computer system for a communication network with a processor that controls switches of FIG. 13, and

FIG. 15 illustrates a link continuity measurement device for the interconnected zone of FIG. 12.

FIG. 1 to 14 have similar parts. The similar parts have similar part names or similar reference numbers. The description of the similar parts is thus incorporated by reference.

FIG. 1 depicts an exemplary embodiment of a “1×2 Attached” interconnected zone 15. The “1×2 Attached” interconnected zone 15 is also known as “dually-attached” interconnected zone. The interconnected zone 15 connects a first communication packet network 16 to a second communication packet network 17.

The first communication packet network 16 includes a first node 19 whilst the second communication packet network 17 includes a second node 21 and a third node 22.

The first node 19 has a first interface 24 and a fourth interface 25. Similarly, the second node 21 has a second interface 26 and the third node 22 has a third interface 27.

The interconnected zone 15 comprises the first node 19, the second node 21 that is connected to the first node 19 via the interfaces 24 and 26, and the third node 22 that is connected to the first node 19 via the interfaces 25 and 27.

The first communication packet network 16 and the second communication packet network 17 provide Ethernet communication services for its users.

The interconnected zone 15 is part of several VLANs (Virtual Local Area Network) that are not shown in FIG. 1 and it supports Ethernet traffic of the VLANs. In a special case, the interconnected zone 15 also supports untagged traffic.

The interconnected zone 15 can support, for example, a DSLAM (Digital Subscriber Line Access Multiplexer), which is attacked through two nodes to a service provider network.

The first node 19 is intended for forwarding Ethernet traffic to the second node 21 or to the third node 22. Ethernet frames used to carry the Ethernet traffic flow over the interfaces in the interconnected zone are described in IEEE 802.1D, IEEE 802.1Q, IEEE 802.1ad, and IEEE 802.1ah documents. The Ethernet traffic carries Ethernet services or Carrier Ethernet services. For a specific VLAN, only the second node 21 or the third node 22 is used at any one time to forward Ethernet traffic.

The Ethernet traffic is carried via a link from one interface on one side of the interconnect zone 15 to another interface on the other side of the interconnect zone 15. This Ethernet traffic is protected against fault condition, failure of the link or one of the interfaces of the interconnect zone 15, or degradation.

The Ethernet traffic can flow via a first link between the interface 24 and the interface 26 or via a second link between the interface 25 and the interface 27. In the event of a fault condition, failure or degradation on the interfaces 24 or 26 or on the first link, the Ethernet traffic is then redirected to the other second link. The fault condition can result from a failure or a degradation that includes link failure, port failure, remote port failure, remote node failure, or administrative operation.

Moreover, the protected Ethernet traffic flow can support a type of Carrier Ethernet service, such as E-Line (Ethernet Line), E-LAN (Ethernet LAN), and E-Tree (Ethernet Tree). The protected Ethernet traffic is also applicable to MEF (Metro Ethernet Forum) service, such as EPL (Ethernet Private Line), EVPL (Ethernet Virtual Private Line), EP-LAN (Ethernet Private LAN), EVP-LAN (Ethernet Virtual Private LAN), EP-Tree (Ethernet Private Tree), or EVP-Tree (Ethernet Virtual Private Tree).

In addition, the protection mechanism enables a rapid detection of failure or of a degradation condition of about 10 milliseconds as well as fast recovery time of less than about 50 milliseconds. The mechanism also allows a service provider to utilize resources in the interconnected zone in an efficient way by handling Ethernet traffic with load sharing. For example, the load sharing can allow overlapping of the protection capacity in order to reduce the total required bandwidth.

The protection of the Ethernet traffic neither depends on, nor requires, a connection or a communication channel between the pair of nodes in the same network.

The protected Ethernet traffic can also be tagged or be untagged. The tagging of Ethernet traffic marks packets of the Ethernet traffic with an internal identifier that can later be used to filter and to translate.

For the tagged Ethernet traffic, protection is implemented per VLAN (Virtual LAN), independent of the other VLANs. The tagging mechanism herein refers to outer VLAN that appears in the Ethernet frame.

Ethernet Traffic from various VLANs can be transmitted via the first link or the second link, which connect the two adjacent networks 16 and 17. The outer VLAN can be in a form of different tags, such as C-VLAN (customer VLAN), S-VLAN (Service VLAN), and B-VLAN (backbone VLAN). In IEEE 802.1Q, IEEE 802.ad, and IEEE 802.1ah switches, untagged Ethernet traffic is tagged by the port VLAN identifier and results in tagged Ethernet traffic. In IEEE 802.1D switches, protection is implemented on the entire Ethernet traffic that is transmitted over the interface.

FIG. 2 depicts an example of a “2×2 Attached” interconnected zone 30. The interconnected zone 30 connects a first communication packet network 31 to a second communication packet network 32.

The first communication packet network 31 has a first node 34 and a second node 35. The first node 34 has a first interface 37 and a second interface 38. The interface is also called a port. Similarly, the second node 35 has a fifth interface 40 and a sixth interface 41.

In a similar manner, the second communication packet network 32 has a third node 44 and a fourth node 45. The third node 44 has a third interface 47 and a fourth interface 48. The fourth node 45 has a seventh interface 50 and an eighth interface 51. The interface is also called a port.

The interconnected zone 30 includes the interfaces 37 and 38 of the first node 34, the interfaces 40 and 41 of the second node 35, the interfaces 47 and 48 of the third node 44, and the interfaces 50 and 51 of the fourth node 45.

The first interface 37 is connected to the third interface 47 whilst the second interface 38 is connected to the seventh interface 50. Similarly, the fifth interface 40 is connected to the fourth interface 48 whilst the sixth interface 41 is connected to the eighth interface 51.

In other words, each of the two nodes 34 and 35 belonging to one network 31 is attached through two interfaces 37 and 38 of the node 34 and two interfaces 40 and 41 of the node 35 to another two nodes of 44 and 45 of the adjacent network 32.

For a specific VLAN, only one of the four interfaces 37, 38, 40, and 41 is used at any one time to forward Ethernet traffic.

The Ethernet traffic flow is carried over one of the interfaces 37, 38, 40, or 41 that connects the two adjacent networks 31 and 32. For example, in the event of a fault condition or failure on one interface 37 of the node 34 or on the co-partner interface 47 of the interface 37, the Ethernet traffic is then redirected to the other interface 38 of the same node 34.

If the node 34 is no longer able to carry the Ethernet traffic, the Ethernet traffic is redirected to another node 35. This node 35 is also called redundant node or protection node.

Following the node protection event, an appropriate notification of a change in network topology is sent to the network 31 in which the protection node 34 or 35 resides. This allows the Ethernet traffic to be directed to the appropriate node 34 or 35. The mechanism used to send the notification depends on the specific packet transport technology that is employed in the network. In a case, wherein Ethernet packet technology is employed, an MVRP (Multiple VLAN Registration Protocol) message can be sent to the network causing relevant entries to be flushed from FDBs (Filtering Data Bases) in the network. In another case, wherein VPLS (Virtual Private LAN Service) is employed, a “MAC Address Withdrawal” message can be sent.

The interconnected zone 30 thus provides a reliable way of transmission without a single point of failure or of degradation. The interconnected zone 30 enables transmission of a Carrier Ethernet service over the interconnected zone 30 through one of the two different nodes 34 or 35 of the network 31 to another one of the two nodes 44 or 45 of the network 32.

FIG. 3 shows the interconnected zone 30 with a protected VLAN (Virtual Local Area Network) of FIG. 2.

FIG. 3 depicts an example of Ethernet traffic of the specific VLAN. The Ethernet traffic of this VLAN is transmitted only via the interface 37 between a node 34 of the first network 31 and a node 44 of the network 32. If a fault occurs on the interface 37, the Ethernet traffic is then redirected to the interface 38 between the node 34 and a node 45. If the node 34 fails, the Ethernet traffic is later redirected via a node 35 and not via the node 34.

The protection mechanism described herein refers to the protection of tagged Ethernet traffic.

The node 34 of the interconnected zone 30 functions as a master. The master is responsible for selecting the interface 37 or 38 over which the related Ethernet traffic is transmitted, while the peer nodes 44 and 45 in the attached network 32 function as slaves, and they follow the master's decisions. The master node 34 is protected by a redundant node 35, which functions as a deputy and is also attached to the two slave nodes 44 and 45. If the master node 34 fails, the deputy node 35 acts as a substitute for the master node 34.

The master is also called a master network device, the deputy is also called a deputy network device, and the slave is also called a slave network device.

In reality, the nodes 34, 35, 44, and 45 can have multiple roles. Each node can act as the master or as the deputy for a specific VLANs as well as the slave for other VLANs.

FIG. 4 shows an example of node functions of the interconnected zone of FIG. 1 and FIG. 2.

FIG. 4(a) depicts an embodiment of a case of a “1×2 Attached” interconnected zone where a node 55 functions as a master and is connected to two slave nodes 56 and 57 of an attached network.

In the “1×2 Attached” scenario, it is also possible to have one slave node 56, which is attached to one master node 55 and one deputy node 58, as depicted in FIG. 4(c).

FIG. 4(b) depicts an embodiment of a case of a “2×2 Attached” interconnected zone where an additional node 58 functions as a deputy and is attached to the two slave nodes 56 and 57 to which the master node 55 is also attached.

A mirroring form is also possible where one of the slave nodes 56 is attached to one master node 55 and one deputy node 57 whilst the other slave node 57 is attached to the same master node 55 and the same deputy node 58, as depicted FIG. 4(d).

In a generic sense, an interconnected zone can be part of several VLANs. Roles of each nodes of the interconnected zone can be different for each respectively VLAN. The role is selected by an administrative configuration for the respective VLAN. Thus, a node may function as the master for some VLANs and as the deputy for other VLANs, thus allowing load sharing between the nodes.

The protection mechanism is performed for one VLAN is independent of other VLANs. The description herein refers to the protection of Ethernet traffic for a specific VLAN. The mechanism works in the same way for every VLAN.

The VLAN can be protected using one port of one node in each of the interconnected networks. As described above, the Ethernet traffic for a specific VLAN can only be transmitted over one interface of one network in the interconnected zone to another interface on the other network at any one time. Each of the networks, such as the first network or the second network, uses one interface so that throughout the interconnected zone, one link with two interfaces is used at any one time.

The node has a forwarding condition, which is defined for each VLAN. The forwarding condition indicates whether the node is in an “active” or “standby” forwarding condition for the Ethernet traffic in the VLAN. For example, referring to FIG. 3, the node forwarding condition of the node A 34 and the node B 44 is “active”, while the node forwarding condition of the node C 35 and the node D 45 is “standby”.

Moreover, ports of the nodes also have a forwarding condition relating to the specific VLAN. The forwarding condition indicates whether the port is in an “active” or “standby” forwarding condition for the Ethernet traffic in the VLAN. For example, referring to FIG. 3, the port forwarding condition of the port 1 37 and the port 3 47 is “active”, while the port forwarding condition of the other port 2 38, the port 4 48, the port 5 40, the port 6 41, the port 7 50, and the port 8 81 is “standby”.

If a fault condition occurs on the interface between the node A 34 and the node B 44, the forwarding condition of the node B 44 is then changed to “standby” and the forwarding condition of the node D 45 is changed to “active”. Similarly, the forwarding condition of the port 2 38 and the port 7 50 is also changed to “active”, while the forwarding condition of the other port 1 37, the port 3 47, the port 4 48, the port 5 40, the port 6 41, and the port 8 51 is then changed to “standby”. Ethernet traffic received in a VLAN may be forwarded to the attached network only through a node and a port, which are in the “active” forwarding condition.

The port also communicates to its peer port of the attached network. The communication includes forwarding condition of its node as well as its own forwarding condition. Using the interconnected zone 30 of FIG. 3 as an example, the port 1 37 sends its node condition and its port condition to the port 3 47. Similarly, the port 3 47 communicates its node state and its port condition to the port 1 37, the port 2 38 sends its node condition and its port condition to the port 7 50, and so on.

A VLAN may be configured for two ports of one node. In a special case, the VLAN can also be configured for one port of each node. One of the ports may have an “active” forwarding condition for that VLAN. In a case of the master node and the deputy node, one of its ports is configured as a working port for that VLAN, while the other port is configured as a protection port for the VLAN. The configuration can assign a preferred port to the “active” forwarding condition by configuring the preferred port to be the “working” port.

In addition, a revertive mode of the VLAN can have a revertive mode or a non-revertive mode of operation. The mode is supported at a node level and at a port level.

When the node is set to the revertive mode, Ethernet traffic is restored to the master node after condition or conditions causing a switchover have been cleared. Similarly, when the node is set to a non-revertive mode, Ethernet traffic remains on the deputy node even after conditions causing the switchover have been solved.

If the port is set to the revertive mode, Ethernet traffic is restored to a “Working” port from a protection port after a condition or conditions causing a switch over to the protection port have been cleared. Likewise, when the port is set to the non-revertive mode, the Ethernet traffic remains on the protection port even after the condition or conditions causing the switch over have been cleared.

At any point in time, the node in an interconnected zone decides which port is used to carry specific Ethernet traffic. This decision is based on a role of the node, such as master, deputy, or slave, as well as its port role, as in case of the master node or the deputy node. The role of the port may be for “working” or for “protecting”. An additional factor to consider is its revertive mode. The decision also considers current forwarding condition of the node, current forwarding condition of the port. Other factors for consideration includes forwarding conditions of its peer nodes and its peer ports of the attached network, as received over the interfaces.

A mechanism for operating the interconnected zone is provided below.

Under normal conditions, when the nodes start up, there is no failure condition in the interconnected zone. The “Working” port is selected to forward Ethernet traffic and this port forwarding condition is set to “active”. If the port cannot forward Ethernet traffic due to a particular reason, such as port failure, or remote port failure, the “protection” port is selected to forward Ethernet traffic and this port forwarding condition is set to “active”. The Ethernet traffic is then directed or switches over to the “protection” port.

Later, the forwarding condition of the “protection” port changes either to “standby” or remains “active” when the condition causing the switchover has been cleared, depending on its revertive mode configuration.

If the master node fails and the deputy node exists, as in the case of the “2×2 Attached” interconnected zone, the deputy node takes over the role of the master node. One of the ports of the deputy node is changed to “active” forwarding condition. If the master node fails and there is no deputy node, as in the case of the “1×2 Attached” interconnected zone, the Ethernet traffic cannot be forwarded through the interconnected zone until the master node recovers. The master node here acts as single point of failure.

The slave nodes adjust themselves according to the decisions of the master node. The forwarding condition of the slave node is “active” if its peer node, which is the master node or the deputy node, is also “active” and if the forwarding condition of its peer port is “active”. In such a scenario, the forwarding condition of the port of the slave node is also “active”.

The forwarding condition of the deputy node is set usually or by default to “standby”. As long as the deputy node learns that one of its peer nodes has an “active” forwarding condition, it concludes that the master node is working and is thus able to forward Ethernet traffic. When the deputy node detects that none of its peer nodes is in an “active” forwarding condition, it concludes that the master node has failed or is unable to forward Ethernet traffic. The deputy node then takes over its role by changing its forwarding condition to “active”, and by selecting one of its ports to forward the Ethernet traffic. The forwarding condition of the selected port is set to “active”. The corresponding slave nodes adjust themselves to the decisions of the deputy node that now acts as a substitute for the master node.

The mechanism described in this embodiment includes messages that are used to communicate the node forwarding conditions and the port forwarding conditions between the peer ports. The mechanism also provides state machines for the respective VLAN. The state machines control the forwarding conditions of the nodes and its corresponding ports of the interconnected zone.

In this example, each node of an interconnected zone has a functional entity named Traffic Forwarding Controller (TFC). The TFC is used to control the node forwarding conditions and the port forwarding conditions. The ports connect the node to the attached network. Different forwarding conditions can be provided for each respective VLAN.

The TFC serves as a logical port that bundles a set of ports of the node. The bundled ports are not considered as bridge ports. Instead, the TFC is perceived as a bridge port, as described by the IEEE 802.1 bridge relay function. The VLANs are considered as members of the TFC, as shown on other bridge port. The TFC is responsible for forwarding Ethernet traffic to the appropriate underlying port, and for collecting Ethernet traffic from the underlying ports. Thus, MAC addresses are learnt on the TFC and not on the underlying ports that are controlled by the TFC.

The TFC is configured for each respective VLAN that it is serving. The configuration includes the one or two underlying ports that are serving the VLAN. VLAN Ethernet traffic is forwarded by the IEEE 802.1 bridge relay function to the TFC when it belongs to the member set of the VLAN, which in turn forwards it to the port that has an “active” forwarding condition. If the TFC does not have a port with an “active” forwarding condition for that VLAN, the Ethernet traffic packets are dropped or ignored.

The TFC keeps information about each VLAN of which it is in the member set. This information includes the forwarding conditions of the node and ports for that VLAN. It may happen that the forwarding condition of a node for a particular VLAN is “active”, while it is “standby” for another VLAN. The node's forwarding condition for a specific VLAN may be “active” only if one of the ports that are controlled by the TFC is in an “active” forwarding condition.

In a generic sense, the master node can decide to let the deputy node take over or switch over the role of handling traffic. The master node can get specific information from the peer slave node that indicates the peer slave node is slowing down or will slow down.

The slave node may also feedback to the master node of remote defect, a client failure of the slave node, or a connectivity problem of the slave node with its own network. The switch over can also be due to administrative reasons.

The deputy node or the master node can conclude or determine a data packet transmission degradation from checksum errors using techniques, such as CRC (cyclic redundancy check) or FRC (frame check sequence). It can also conclude from bad results of a performance monitoring between the master node and the slave node or between the deputy node and the slave node, such as long delay, long delay variation, or data packet loss exceed a certain threshold.

In a special case, the deputy node can decide to take over the role of the master node when it does not receive master node status information after a period time. The master node can decide to change traffic flow direction after not receiving slave node status information after a period or a certain delay.

The communication means between the nodes can be used to exchange information between the master node and the deputy node via the slave node and between the two slaves either via the master node or via the deputy node. This information may include synchronization of the protection status, indications of administration requests, like switch over, switch back, synchronization of configuration, information related to the status of the network that they reside.

After changing the transmission direction, the network topology is changed. The respective network is informed of the changed network topography so that the network knows about the new node for communication with the other communication network.

The two slaves or the master node and the deputy node are not a single device but a multiplicity of devices. It is also not a single logical device, which can be seen as the slave nodes, the master node, and the deputy node have different network addresses.

A physical node can serve different roles for different VLANs. For example, it can serve as the master node for one VLAN, and as the deputy node for another VLAN.

### State Machines

A state machine is provided for each of the three types or roles of nodes per traffic flow, which is master, deputy, and slave. The state machines reside in the TFC and are defined for each supported VLAN. The state machine determines the forwarding condition of one or two ports for which the VLAN is defined and the forwarding condition of the node for that VLAN. The forwarding condition may change because of events that occur locally in the node, or remotely in the peer nodes, or in the interfaces that connect to the peer nodes. The forwarding conditions of the remote peer and of its ports, resulting from events occurring on the remote peer node are communicated using the messages described below.

### Master State Machine

FIG. 5 shows an example of a table 60 of a state machine of the master node. The master node is connected to one slave node through the “Working” port of the master node. The master node can also be connected to another slave node through the “Protection” port of the master node.

In the “1×2 Attached” construction, the master node can be connected to one or two slave nodes whilst in the “2×2 Attachment” construction, the master node is connected to two slave nodes.

The master state machine has an Idle state 81, an Init state 82, a Working state 83, and a Protection state 84. The Init state 82 is also called an Initial state.

The Idle state 82 indicates that the TFC is not forwarding Ethernet traffic. The node forwarding condition is “standby”. The port forwarding condition for both the “Working” and “Protection” ports is “standby”.

In the Init state 82, the node forwarding condition is “active” but the forwarding condition of both “Working” and “Protection” ports is “standby”. None of the ports forward Ethernet traffic.

The Init state 82 is a transient state, which occurs in revertive mode at the node level when a failed master node has recovered and before it resumes Ethernet traffic forwarding. In this state, the deputy node is informed that the master node has recovered and that the master node wishes to forward Ethernet traffic. This state is intended to prevent a situation from arising, wherein two nodes acts as master nodes at the same time and wherein more than one port forward network Ethernet traffic for the same VLAN at the same time.

The Working state 83 indicates that the forwarding conditions for the node and the “Working” port are “active”. The “Protection” port is in the “standby” forwarding condition.

The Protection state 84 indicates that the node is in an “active” forwarding condition, that the “Protection” port is in the “active” forwarding condition, and that the “Working” port is in the “standby” forwarding condition.

This state is applicable when the “Working” port cannot forward Ethernet traffic. This can occur because of a fault condition or it can occur following a recovery from a fault condition in the non-revertive mode at the port level.

Columns in the table show local state 62 of the master node, forwarding condition 63 of the “Working” port, forwarding condition 64 of the “Protection” port, and forwarding condition 65 of the node.

The columns also show node and port forwarding conditions 66 and 67 of the slave node to which the master node is connected through the “Working” port. Information of these forwarding conditions 66 and 67 of the slave node is communicated to the “Working” port by the slave node.

Similarly, the column depicts node and port forwarding conditions 69 and 70 of the slave node to which the master node is connected through the “Protection” port. Information of these forwarding conditions 60 and 70 is communicated to the “Protection” port by the slave node.

The table also depicts new local state 72, new forwarding condition 73 of the “Working” port, new forwarding condition 74 of the “Protection” port, and new node forwarding condition 75 of the master node.

FIG. 6 depicts an example of a state flow chart 80 of the master state machine.

### Deputy State Machine

FIG. 7 shows an example of a table 85 of the state machine of the deputy node that is connected to the slave nodes via the “Working” port and the “Protection” port.

The deputy state machine has an Idle state 86, a Working state 87, and a Protection state 88. These states are similar to the states of the master state machine, as described above. The deputy node starts in the IDLE state.

Columns of the table show local state 90, forwarding condition 91 of the “Working” port, forwarding condition 92 of the “Protection” port, and forwarding condition 93 of the node.

The table also shows node and port forwarding conditions 95 and 96 of the slave node to which the deputy node is connected through the “Working” port. Information of the node and port forwarding conditions 95 and 96 is communicated to the “Working” port by the slave node.

Similarly, the table has node and port forwarding conditions 98 and 99 of the slave node to which the deputy node is connected through the “Protection” port. Information of the node and port forwarding conditions 98 and 99 is communicated to the ‘Protection” port by the slave node.

New forwarding condition 101 of deputy node, new forwarding condition 102 of the “Working” port, new forwarding condition 103 of the “Protection” port, and new local state 104, is also depicted in the table 85.

A state flow chart 106 of the deputy state machine is depicted in FIG. 8.

### Slave State Machine

FIG. 9 shows an example of a table 110 that defines the state machine of the slave node that is connected to the master node and, depending on the construction of the interconnected zone, to the deputy node. The interconnected zone can include the “1×2 Attached” interconnected zone or the “2×2 Attached” interconnected zone.

The slave state machine has an Idle state 112, a Master state 113, and a Deputy state 114.

In the Idle state 112, the slave node is not forwarding Ethernet traffic. The forwarding conditions of the slave node and its one or two ports are “standby”.

The Master state 113 shows that forwarding condition of the slave node is “active” and forwarding condition of its port through which it is connected to the master node is “active”.

Similarly, the Deputy state 114 indicates that forwarding condition of the slave node is “active” and forwarding condition of its port through which it is connected to the deputy node is “active”.

The slave node activates its port on which it receives a message, indicating that its peer port is in an “active” forwarding condition.

The slave node deactivates a port when it detects a fault condition or when it receives certain information indicating a change in the network. For example, when the deputy node is in the “active” forwarding condition, and the master node has just recovered and it wants to regain the master role, the slave node receives information from its first port and its second port, indicating that both the deputy node and the master nodes are in the “active” forwarding condition. In this case, the slave node changes forwarding condition of its port to “standby”.

Columns of the table indicate local state information 120, forwarding conditions 121 and 122 of the ports that are connected to the master and the deputy via the first and the second ports of the slave node, and forwarding condition 124 information of the slave node.

The table also shows forwarding condition 126 of the master node that is connected to the first port of the slave node and forwarding condition 127 of the port of the master node that is connected to the first port for receiving the states of the master node.

It also shows forwarding condition 130 of the deputy node that is connected to the second port of the slave node and forwarding condition 131 of the port of the deputy node that is connected to the second port for receiving the states of the deputy node.

In addition, it displays new forwarding conditions 135 and 136 of the first and the second ports of the slave node, new forwarding condition 137 of the slave node, and new local state 138.

FIG. 10 shows an example of a state flow chart 140 of the slave state machine of FIG. 9.

### Packet Structure

An IEEE 802.1ag protocol and extensions of its link-level CCM (Continuity Check Message) message is provided below. Although the extension support the above-mentioned embodiment, other implementation to support the embodiment is also possible.

The CCM message has a TLV (Type/Length/Value), which is used to communicate the forwarding conditions of the node and the port for each VLAN is provided below. This TLV is included in the link-level CCM messages that are generated by the ports, which are controlled by the TFC. Each port creates the TLV according to its condition. The TLV is called TFC TLV. Its type field is 9, which is the first available free value in table 21-6 of IEEE 802.1ag document. The structure of the TFC TLV has Type field with value “9”, Length field with a value “1024”, and values.

For each VLAN, two bits are allocated in the TLV to indicate the forwarding conditions of the node and port for this VLAN.

The first bit indicates the node's forwarding condition for this VLAN. The value “0” in this bit indicates that the node is in the “standby” forwarding condition and does not forward Ethernet traffic in this VLAN. The value “1” in this bit indicates that the node is in the “active” forwarding condition and is ready to forward Ethernet traffic in this VLAN.

The second bit indicates the forwarding condition of the port regarding this VLAN. The value “0” in this bit indicates that the port is in the “standby” forwarding condition and does not forward Ethernet traffic in this VLAN. The value “1” indicates that the port is in the “active” forwarding condition and forwards Ethernet traffic in this VLAN.

The first two bits of the TFC TLV indicate the information relating to VLAN number 1. The next two bits in the TFC TLV indicate the status relating to VLAN number 2, and so on until VID 4096. This structure is similar to the structure used in the IEEE 802.1ak MVRP (Multiple VLAN Registration Protocol). In this case, only two bits are used per VLAN in contrast to the MVRP, which uses three bits per VLAN.

In the special case of untagged Ethernet traffic, the first two bits indicate the status of the entire Ethernet traffic.

FIG. 11 depicts an example of a structure 145 for TFC TLV (Type/Length/Value) in the 802.1ag CCM (Continuity Check Message).

The 802.1ag protocol is used for fault management and it may be used over an interface. When CCM messages are used to detect a fault condition and to trigger protection switching, it is common to set the transmission rate for CCM messages to 3.3 ms (milliseconds). Thus, a loss of three CCM messages, which is used to trigger a protection switching event, can be detected in as little as 10.8 milliseconds. Using the CCM messages to communicate the forwarding conditions of the VLAN between peer ports ensures that a fault condition in an interconnected zone can be rapidly detected, and that a below 50 milliseconds protection switching can be achieved. It is believed that processing the information defined in the CCM message for all VLANs can be performed at wire speed. The wire speed refers to a hypothetical maximum data transmission rate of a cable or other transmission medium.

In other words, this embodiment provides a fast recovery mechanism of below 50 milliseconds that is aimed at protecting a type of Carrier Ethernet service against failure or facility degradation in an interconnected zone, whilst preventing a single point of failure or degradation in the interconnected zone between packet networks. The mechanism is applied to “2×2 Attached” and “1×2 Attached” interconnected zones.

The attached network may employ a different packet transport technology, such as Ethernet 802.1ah, Ethernet 802.1ad, MPLS-TP, or L2-MPLS. It uses its own resiliency mechanism to protect network operation. The mechanism described in this embodiment, together with the resiliency mechanisms employed in the attached network, enable the immediate detection of facility failure or degradation. Network operation can be rapidly restored, after the detection of failure or degradation. This enables compliance with terms of SLA (Service Level Agreement) for an end-to-end Carrier Ethernet service that is delivered over the interconnected networks.

The mechanism defined in this embodiment does not require connectivity or a communication channel between the pair of nodes on either side of the interconnected zone.

This mechanism is based on Ethernet Connectivity Fault Management according to 802.1ag, with enhancements to the Continuity Check protocol to allow communication of the protection states between the nodes in the interconnected zone. The information on the protection states functions in conjunction with the CCM packets. This allows rapid fault detection and coordination of the protection state in order to perform fast protection switching when needed.

Network survivability plays a critical factor in the delivery of reliable Carrier Ethernet services and it is believed to be a significant contributor to revenue and profit.

The embodiment supports Carrier Ethernet services, which provides worldwide services that traverse inter-domain, inter-carrier, and inter-packet-technology networks as well as national and global networks. Access networks provide availability over fibre, copper, cable, PON (Passive Optical Network), and wireless to a much wider class of user. Carrier Ethernet services enable economy of scale from converged business, residential, and wireless networks sharing the same infrastructure and services, with the ability to rapidly deploy different kinds of applications while retaining the cost model and simplicity of Ethernet.

The Carrier Ethernet services brings business benefits to enterprises, to sectors such as healthcare, finance, education, government, and media as well as to applications like site-to-site access, business continuity, and disaster recovery. Reliability is one of the key benefits that Carrier Ethernet services bring to this market.

The Carrier Ethernet services are also used for mobile backhauling with applications for voice, video, and data. The backhauling refers to sending data to a network backbone. The services economically meet growing bandwidth requirements that are currently constrained by the prohibitive costs of legacy networks, such as TDM (Time Division Multiplexing) network. The Carrier Ethernet services provide the necessary reliability, with SLA support and OAM (Operations Administration Maintenance) capabilities for mobile backhauling applications. Reliability is a key requirement for these applications as well as for residential services and entertainment applications.

Using the mechanism described here, carriers can provide the required level of end-to-end resiliency by supplying Carrier Ethernet services over interconnected networks that comply with the terms of SLA.

The embodiment offers resiliency of Carrier Ethernet services in an interconnected zone, whilst preventing a single point of failure and degradation as well as providing end-to-end solutions over CET (Carrier Ethernet Transport), such as MBH, business service, residential services, and converged networks.

FIG. 12 depicts the “2×2 Attached” interconnected zone 30 of FIG. 13 with embodiments of functional elements of several VLANs.

The interconnected zone 30 has the nodes 34 and 35 of the first communication packet network 31 as well as the nodes 44 and 45 of the second communication packet network 32.

The node 34 has the ports 37 and 38 whilst the node 44 has the ports 47 and 48. The node 35 has the ports 40 and 41. The node 45 has the ports 50 and 51. The port is also called interface.

The port 37 is connected to the port 47 in node 44 via a physical link 150 whilst the port 38 is connected to the port 50 via a physical link 151. The port 40 is connected to the port 48 via a physical link 156 whilst the port 41 is connected to the port 51 via a physical link 157.

Each of the nodes 34, 35, 44, and 45 has a master functional element, a deputy functional element, and a slave functional element. The functional element of the nodes 34, 35, 44, and 45 may support multiple VLANs.

The node 34 has a master functional element 160, a deputy functional element 161, and a slave functional element 163. Likewise, the node 35 has a deputy functional element 165, a master functional element 166, and a slave functional element 167. The node 44 has slave functional elements 169 and 170 and a deputy functional element 171. The node 45 has slave functional elements 173 and 174 and a master functional element 175.

The functional elements 160 to 175 allow the nodes 34, 35, 44, and 45 to act like the master, the deputy, or the slave. The role of the nodes 34, 35, 44, and 45, which can be a master, a deputy, or a slave, is defined by an administrative configuration for each particular VLAN. Thus, the node 34, 35, 44, or 45 may function as a master for certain VLANs and as a deputy to other VLANs and as a slave to other VLANs. This arrangement allows load sharing between the nodes 34, 35, 44, and 45.

In this example, a VLAN 1 includes the node 34 that functions a master, the node 35 that functions as a deputy, the node 44 that functions as a slave, and the node 45 that functions as a slave.

The master functional element 160 is connected functionally to the slave functional element 169 via a functional link 177 and to the slave functional element 173 via a functional link 178. The deputy functional element 165 is connected functionally to the slave functional element 169 via a functional link 180 and to the slave functional element 173 via a functional link 181.

Similarly, a VLAN 2 includes the node 34 that functions a deputy, the node 35 that functions as a master, the node 44 that functions as a slave, and the node 45 that functions as a slave.

The master functional element 161 is functional connected to the slave functional element 170 via a functional link 183 and to the slave functional element 174 via a functional link 184. The master functional element 165 is functional connected to the slave functional element 170 via a functional link 186 and to the slave functional element 174 via a functional link 185.

In addition, a VLAN 3 includes the node 34 that functions a slave, the node 35 that functions as a slave, the node 44 that functions as a deputy, and the node 45 that functions as a master.

The slave functional element 163 is functional connected to the deputy functional element 171 via a functional link 187 and to the master functional element 175 via a functional link 188. The slave functional element 167 is functional connected to the deputy functional element 171 via a functional link 190 and to the master functional element 175 via a functional link 191.

The functional links 177, 183, and 187 of the physical link 150 carries Ethernet flows. Each functional link supports a specific VLAN and is different from a functional element. In a physical link, many VLANs can traverse. Since the functional element of different VLANs 160, 161, and 163 of node 34 are different, a specific VLAN can use a different link 150, 151, 156, or 157 at different times.

Dependent on the protection status, the traffic of the VLANs 1, 2 and 3 between nodes 34 and 44 may be transmitted over the physical link 150 between the ports 1 and 3.

Likewise, the traffic of the VLANs 1, 2 and 3 between nodes 34 and 45 can be transmitted over the physical link 151 between the ports 2 and 7. The traffic of the VLANs 1, 2 and 3 between nodes 35 and 44 may be transmitted over the physical link 156 between the ports 5 and 4. The traffic of the VLANs 1, 2 and 3 between node 35 and 45 may be transmitted over the physical link 157 between the ports 6 and 8.

The protection mechanism for data packet transmission for each VLAN 1, 2, or 3 is independent of the protection mechanism of the other VLANs.

FIG. 13 shows an example of an end-to-end connectivity 200 using switches for delivery of network services for Customer Edge Equipments CE1, CE2, and CE3.

The CE3 is connected to a network 202 of a Service Provider 1 via the “1×2 Attached” interconnected zone 15 of FIG. 1 whilst the network 202 is connected to a network 203 of a Service Provider 2 via the “2×2 Attached” interconnected zone 30 of FIG. 2.

A switch H of the network 203 is connected to a switch K via a 1 GB (Gigabyte) link 205. The switch K is connected to the CE1. Similarly, a switch J of the network 203 is connected to a switch L via a 1 GB link 206. The switch L is connected to the CE2.

The CE3 of a network 208 is a switch E (the node 24 of FIG. 1). The switch E is connected to the network 202 via a 1 GB link 210 and a 1 GB link 211.

A first end of the link 210 is connected to a first port in the switch E whilst a second end of the link 210 is connected to a port in a switch F (the node 26 of FIG. 1). Similarly, a first end of the link 211 is connected to a second port in the switch E whilst a second end of the link 211 is connected to a port in a switch G (the node 22 of FIG. 1). This implementation constructs the “1×2 Attached” interconnected zone 15.

A switch A (the node 34 of FIG. 2) of the network 202 is dual attached to the network 203 of Service Provider 2 via two 10 GB links 150 and 151. The links 150 and 151 are attached to two different ports of different line cards of the switch A. Similarly, a switch C (the node 34 of FIG. 2) is dual attached to the network 203 via two 10 GB links 156 and 157. The links 156 and 157 are attached to two different ports of different line cards of the switch C.

The 10 GB link 151 and the 10 GB link 157 connect to different line cards of the switch D. Likewise, the 10 GB link 150 and the 10 GB link 156 connect to different line cards of the switch B.

The switches A, B, C, D, E, F, G, H, and J refer to a device that route or forward data packets.

In a certain case, the CE3 transmits data packets via the switch E to the switch F or to the switch G. For a certain VLAN, the switch E can act as master whilst the switch F and the switch G act as slaves.

The network 202 may also transmit the data packets to the network 203. For a particular VLAN, the switch A can act as a master, the switch C can act a deputy, the switches B and D can act as slaves. Embedded computers for the switches A, B, C, D, E, F, and G can configure the switches A, B, C, D, E, F, and G.

Several VLANs can transmit data packets from the CE3 to the network 202 of Service Provider 1 are supported by the 1 GB links 210 and 211.

In an example, the CE3 functions as a master for all VLANs that transmit between the CE3 and the network 202.

For some of the VLANs, the port that connects the CE3 to the switch F is configured as a working port and the port that connects the CE3 to the switch G is configured as a protection port. For other VLANs, the port that connects the CE3 to switch F is configured as a protection port and the port that connects the CE3 to switch G is configured as a working port.

For a VLAN X, the switch A functions as a master, the switch C functions as a deputy, the switches B and D function as slaves. Dependent on a configuration of working and protection ports of the VLAN X and on its protection status, traffic of the VLAN X is transmitted over one of the 10 GB links 150, 151, 156, and 157 in the “2×2 Attached” interconnected zone 30.

Similarly, for a VLAN Y, the switch A functions as a deputy, the switch C functions as a master, the switches B and D function as slaves. Dependent on a configuration of working and protection ports of the VLAN Y and on its protection status, traffic of the VLAN Y is transmitted over one of the GB links 150, 151, 156, and 157 in the “2×2 Attached” interconnected zone 30.

For the VLAN Z, the switches A and C function as slaves, the switch B functions as a deputy, and the switch D functions as a master. Dependent on a configuration of working and protection ports of the VLAN Z and on its protection status, traffic of the VLAN Z is transmitted over one of the 10 GB links 150, 151, 156, and 157 in the “2×2 Attached” interconnected zone 30.

FIG. 14 shows an example of a computer system 220 for a communication network with a processor that controls the switch A of FIG. 13.

The computer system 220 is embedded within the network node 34. The computer system 220 includes a processor 222 that is connected to a RAM (Random Access Memory) 223, a ROM (Read Only Memory) 225, and to the two ports 37 and 38.

In this case, the physical link 150 of FIG. 13 is connected to the port 37 whilst the physical link 151 is connected to the port 38.

The processor 222 can be in the form of a RISC (Reduced Instruction Set Computing) processor. The processor 222 receives a program and data from the ROM 223. Based on the program and the data, the processor 222 decides on a handling, switching or relaying of data packets that it receives from the ports 37 and 38. The RAM 223 acts a storage area for the program.

The program is intended for managing the data packets that the ports 37 and 38 receives or sends. The ports 37 and 38 act as terminal points for receiving the external data packets, sending the data packets to the processor 222 for processing or managing, and forwarding the data packets as directed by the processor 222. As provided here, functionality and message processing is done in hardware.

The program allows the switch A to act as the master, the deputy, or the slave for a particular VLAN. The switch A can support several VLANs. Each individual VLAN is supported independently of other VLANs.

In a generic sense, a computer system that is similar to the computer system 220 controls the switches B, C, D, E, F, G, H, K, J, or L of FIG. 13. The computer system is usually a type of embedded systems that performs dedicated functions.

The program implements the method steps of the master network device, deputy network device, or slave network device, as described earlier above, using software code and is being run using the processor 222. The software code relates to a certain programming language. The program can include an operating system, such as a real time operating system.

The method steps or the network devices can be implemented as hardware components using a certain hardware technology, such as MOS (Metal Oxide Semiconductor), CMOS (Complementary Metal Oxide Semiconductor), BiCMOS (Bipolar Complementary Metal Oxide Semiconductor), ECL (Emitter Coupled Logic), or TTL (Transistor-Transistor Logic). The hardware components can comprise ASIC (Application Specific Integrated Circuit) components or DSP (Digital Signal Processing) components. The hardware components can also include FPGA (Field Programmable Gate Array). The method steps can also be implemented using software, hardware, or combination of software and hardware. The hardware includes individual discrete components.

FIG. 15 depicts an example of a link continuity measurement device 240 for the interconnected zone 30 of FIG. 12.

The link continuity measurement device 240 includes a voltage signal source 242 of the node 34 and a voltmeter 243 of the node 44. The voltage signal source 242 is placed at a first end of the physical link 150 whilst the voltmeter 243 is placed and is at a second end of the physical link 150. The voltage signal source 242 is connected to an electrical ground.

A terminating resistor 244 is also placed in parallel with the voltmeter 243 at the second end of the physical link 150. The terminating resistor 244 is connected to the electrical ground via a blocking inductor 248.

The second end of the physical link 150 is connected to a terminal 250 of the node 44 via a blocking capacitor 245 whilst the first end of the physical link 150 is connected to a terminal 249 of the node 34 via a blocking capacitor 246.

The physical link 150 has a shielding 247 that is connected to an electrical ground at both of its end.

The voltage signal source 242 is intended for transmitting a 5 volts DC (direct current) signal over the physical link 150. The voltage signal produces a voltage drop across the terminating resistor 244, which is measured by the voltmeter 243. The terminating resistor 244 has a resistance of 5 kilo-ohms. The measured voltage drop is used for determining an electrical continuity of the physical link 150. The blocking capacitors 245 and 246 are intended for isolating the terminals 249 and 250 from the DC voltage signal of the voltage signal source 242. Each of the blocking capacitors 246 and 245 includes a 100 μF (micro-farad) capacitor, a 1 μF capacitor, a 1 nF (nano-farad), and a 10 pF (pico-farad) capacitor connected in parallel so AC signals can go through over a wide signal bandwidth.

The terminals 249 or 250 transmit an AC (alternating current) network signal to each other. The AC network signal carries data packet information. A voltage detection circuit at the respective terminal receives the AC network signal. This AC network signal is isolated from the terminating resistor 244 by the blocking inductor 248 and from the voltage signal source 242 by the blocking inductor 241. The shielding 247 is used for insulating the link 150 from electrical noise.

Based on the electrical continuity of the physical link 150, the functional elements of the node 34 or 44 can determine a working condition of the physical link 150. For example, the physical link 150 may be disconnected from the node 34. Using the determined working condition, the node 34 or 44 can decide to transmit the data packets to other nodes. In this way, the data packet transmission is protected. The node 44 can also send an operational status of the link 150 to other node.

In a generic sense, other methods of determining an electrical continuity of the link 150 are also possible. The methods include using an electrical current signal or a reflection of an electrical pulse to measure the electrical continuity. An signal analysis can also be used to measure the electrical continuity.

The monitoring of electrical continuity of the link 150 can be done in a continuously mode or regular basis.

### LIST OF ABBREVIATIONS

B-VLAN Backbone VLAN
C-VLAN Customer LAN
CCM Continuity Check Message
CET Carrier Ethernet Transport
CPE Customer Premise Equipment
DSLAM Digital Subscriber Line Access Multiplexer
E-LAN Ethernet LAN
E-Line Ethernet Line
EPL Ethernet Private Line
EP-LAN Ethernet Private LAN
EP-Tree Ethernet Private Tree
ETH Ethernet
E-Tree Ethernet Tree
ETY Ethernet Physical Layer
EVPL Ethernet Virtual Private Line
EVP-LAN Ethernet Virtual Private LAN
EVP-Tree Ethernet Virtual Private Tree
FDB Filtering Data Base
FDBs Filtering Data Bases
GFP Generic Framing Procedure
IEEE Institute of Electrical and Electronics Engineers
IETF Internet Engineering Task Force
IP Internet Protocol
LACP Link Aggregation Control Protocol
LAG Link Aggregation
LAN Local Area Network
MAC media access control
MC-LAG Multi Chassis LAG
MDLA Multi Device Link Aggregation
MEF Metro Ethernet Forum
MPLS Multiprotocol Label Switching
MVRP Multiple VLAN Registration Protocol
OAM Operation Administration Maintenance
PE Provider Edge
PON Passive Optical Network
SLA Service Level Agreement
SMLT Split Multi Chassis LAG
S-VLAN Service VLAN
TDM Time Division Multiplexing
TFC Traffic Forwarding Controller
TLV Type/Length/Value
VLAN Virtual LAN
VPLS Virtual Private LAN Service
WDM Wavelength Division Multiplexing
STP Spanning Tree Protocol

### REFERENCE NUMBERS

15 “1×2 Attached” interconnected zone
16 first communication packet network
17 second communication packet network
19 first node
21 second node
22 third node
24 first interface
25 fourth interface
26 second interface
27 third interface
30 “2×2 Attached” interconnected zone
31 first communication packet network
32 second communication packet network
34 first node
35 second node
37 first interface
38 second interface
40 fifth interface
41 sixth interface
44 third node
45 fourth node
47 third interface
48 fourth interface
50 seventh interface
51 eighth interface
55 master node
56 slave node
57 slave node
58 deputy node
60 table
62 local state
63 forwarding condition
64 forwarding condition
65 forwarding condition
66 forwarding condition
67 forwarding condition
69 forwarding condition
70 forwarding condition
72 local state
73 forwarding condition
74 forwarding condition
75 forwarding condition
80 state flow chart
81 Idle state
82 Init state
83 Working state
84 Protection state
85 table
86 Idle state
87 Working state
88 Protection state
90 local state
91 forwarding condition
92 forwarding condition
93 forwarding condition
95 forwarding conditions
96 forwarding condition
98 forwarding condition
99 forwarding condition
101 forwarding condition
102 forwarding condition
103 forwarding condition
104 local state
106 state flow chart
110 table
112 Idle state
113 Master state
114 Deputy state
120 state information
121 forwarding condition
122 forwarding condition
124 forwarding condition
126 forwarding condition
127 forwarding condition
130 forwarding condition
131 forwarding condition
135 forwarding condition
136 forwarding condition
137 forwarding condition
138 local state
140 state flow chart
145 structure
150 link
151 link
156 link
157 link
150 physical link
151 physical link
156 physical link
157 physical link
160 master functional element
161 deputy functional element
163 slave functional element
165 deputy functional element
166 master functional element
167 slave functional element
169 slave functional element
170 slave functional element
171 deputy functional element
173 slave functional element
174 slave functional element
175 master functional element
177 functional link
178 functional link
180 functional link
181 functional link
183 functional link
184 functional link
186 functional link
185 functional link
187 functional link
188 functional link
190 functional link
191 functional link
200 connectivity
202 network
203 network
205 link
206 link
208 network
210 link
211 link
220 computer system
222 processor
223 RAM (Random Access Memory)
225 ROM (Read Only Memory)
240 link continuity measurement device
241 blocking inductor
242 voltage signal source
243 voltmeter
244 terminating resistor
245 blocking capacitor
246 blocking capacitor
247 shielding
248 blocking inductor
249 terminal
250 terminal
CE1 Customer Edge Equipment
CE2 Customer Edge Equipment
CE3 Customer Edge Equipment
A switch
B switch
C switch
D switch
E switch
F switch
G switch
H switch
J switch
K switch
L switch

1-59. (canceled)

60. A method of transmitting data packets of a first communication network to a second communication network,
the first communication network having:
a master network device of the first communication network connected to a slave network device of the second communication network; and
a deputy network device of the first communication network connected to the slave network device of the second communication network;
the method which comprises the following steps:
transmitting the data packets from the master network device to the slave network device;
transmitting from the slave network device a slave network device operational status information to the deputy network device;
monitoring, with the deputy network device, a slave network device operational status; and
transmitting the data packets from the deputy network device to the slave network device when detecting a slave network device predetermined operational status information.

61. The method according to claim 60, which comprises stopping a transmission of the data packets from the deputy network device to the slave network device when detecting a slave network device predetermined operational status.

62. The method according to claim 60, which further comprises:
transmitting from the slave network device slave network device operational status information to the master network device; and
transmitting from the master network device the data packets to the slave network device upon receiving a slave network device predetermined operational status; and
stopping a transmission of the data packets from the master network device to the slave network device when receiving a slave network device predetermined operational status.

63. The method according to claim 60, which further comprises transmitting from the master network device a master network device operational status information to the slave network device.

64. The method according to claim 63, which further comprises:
receiving the master network device operational status information with the slave network device; and
adapting a slave network device operational mode using a master network device predetermined operational status.

65. The method according to claim 63, which further comprises:
transmitting the master network device operational status information from the slave network device to the deputy network device;
monitoring, with the deputy network device, the master network device operational status; and
transmitting the data packets from the deputy network device to the slave network device upon not receiving a master network device predetermined operational status.

66. A network node for use in an interconnected zone of a first communication network and a second communication network, the network node being interconnected with at least one further network node of the interconnected zone via at least one interconnection link, the network node comprising:
at least one port for transmitting data packets to the at least one further network node; and
at least one controller for ruling a transmission of the data packets on the at least one port, said at least one controller being configured to rule the transmission of the data packets in accordance with any one of a role of a master network device, a role of a slave network device, or a role of a deputy network device.

67. The network node according to claim 66, wherein said at least one port is one of a plurality of ports and mutually different roles of the master network device, the slave network device, and the deputy network device can be assumed for each one of said ports.

68. The network node according to claim 67, wherein the role of a master network device comprises:
transmitting data packets to the slave network device when receiving a slave network device predetermined operational status; and
stopping a transmission of the data packets to the slave network device when receiving a slave network device predetermined operational status.

69. The network node according to claim 67, wherein the role of the master network device comprises:
transmitting a master network device operational status information to the slave network device.

70. The network node according to claim 67, wherein the role of a slave network device comprises:
transmitting slave network device operational status information to the master network device; and
transmitting slave network device operational status information to the deputy network device.

71. The network node according to claim 67, wherein the role of a slave network device comprises:
receiving master network device operational status information; and
adapting a slave network device operational mode using a master network device predetermined operational status.

72. The network node according to claim 67, wherein the role of a slave network device comprises:
receiving a master network device operational status information; and
transmitting the master network device operational status information to the deputy network device.

73. The network node according to claim 67, wherein the role of a deputy network device comprises:
receiving slave network device operational status information from a slave network device;
monitoring a slave network device operational status;
transmitting the data packets to the slave network device upon detecting a slave network device predetermined operational status information; and
stopping a transmission of the data packets to the slave network device upon detecting a slave network device predetermined operational status.

74. The network node according to claim 67, wherein the role of a deputy network device comprises:
receiving master network device operational status information from the slave network device;
monitoring a master network device operational status; and
transmitting the data packets to the slave network device upon receiving a master network device predetermined operational status.

75. The network node according to claim 66, wherein the role of a master network device comprises:
transmitting data packets to the slave network device when receiving a slave network device predetermined operational status; and
stopping a transmission of the data packets to the slave network device when receiving a slave network device predetermined operational status.

76. The network node according to claim 66, wherein the role of the master network device comprises:
transmitting a master network device operational status information to the slave network device.

77. The network node according to claim 66, wherein the role of a slave network device comprises:
transmitting slave network device operational status information to the master network device; and
transmitting slave network device operational status information to the deputy network device.

78. The network node according to claim 66, wherein the role of a slave network device comprises:
receiving master network device operational status information; and
adapting a slave network device operational mode using a master network device predetermined operational status.

79. The network node according to claim 66, wherein the role of a slave network device comprises:
receiving a master network device operational status information; and
transmitting the master network device operational status information to the deputy network device.

80. The network node according to claim 66, wherein the role of a deputy network device comprises:
receiving slave network device operational status information from a slave network device;
monitoring a slave network device operational status;
transmitting the data packets to the slave network device upon detecting a slave network device predetermined operational status information; and
stopping a transmission of the data packets to the slave network device upon detecting a slave network device predetermined operational status.

81. The network node according to claim 66, wherein the role of a deputy network device comprises:
receiving master network device operational status information from the slave network device;
monitoring a master network device operational status; and
transmitting the data packets to the slave network device upon receiving a master network device predetermined operational status.

82. A network node computer system for controlling the network node according to claim 66, the network node computer system comprising:
a processor connected to a memory and to the at least one port;
the network node computer system controlling a handling of data packets at the at least one port;
said memory having loaded therein a computer program in non-transitory form causing the computer system to execute the roles of any of a master network device, a deputy network device, or a slave network device.

83. The network node computer system according to claim 82, wherein the at least one port is one of a plurality of ports, and wherein different roles out of the master, the deputy and the slave network device can be assumed simultaneously for controlling the handling of data packets on different ports according to the different roles.
